(19) United States
(12) Patent Application Publication
(10) Pub. No.: US 2026/0252684 A1
(43) Pub. Date: Aug. 27, 2026

(54) COMPUTER-IMPLEMENTED METHOD AND COUNTERMEASURE ARTIFICIAL INTELLIGENCE AUTHENTICATION SYSTEM FOR DETECTING AND DEFEATING AN AUTOMATED ARTIFICIAL INTELLIGENCE BYPASS ATTEMPT

(71) Applicant: The Mirror Project LLC, Boca Raton, FL (US)

(72) Inventor: Scott Lipskin, Boca Raton, FL (US)

(73) Assignee: The Mirror Project LLC, Boca Raton, FL (US)

(21) Appl. No.: 19/648,201

(22) Filed: Apr. 15, 2026

Related U.S. Application Data
(63) Continuation-in-part of application No. 19/635,099, filed on Mar. 31, 2026.
(63) Continuation-in-part of application No. 19/576,524, filed on Mar. 24, 2026, now Pat. No. 12,712,858.
(63) Continuation-in-part of application No. 19/534,902, filed on Feb. 10, 2026.
(63) Continuation-in-part of application No. 19/461,799, filed on Jan. 28, 2026.
(63) Continuation-in-part of application No. 19/455,887, filed on Jan. 22, 2026.
Application No. 19/455,887 is a continuation-in-part of application No. 19/452,930, filed on Jan. 20, 2026.
Application No. 19/455,887 is a continuation-in-part of application No. 19/440,705, filed on Jan. 6, 2026.
Application No. 19/455,887 is a continuation-in-part of application No. 19/438,974, filed on Jan. 2, 2026.
Application No. 19/455,887 is a continuation-in-part of application No. 19/436,069, filed on Dec. 30, 2025.
Application No. 19/455,887 is a continuation-in-part of application No. 19/432,500, filed on Dec. 24, 2025.
Application No. 19/455,887 is a continuation-in-part of application No. 19/425,024, filed on Dec. 18, 2025.
(60) Provisional application No. 64/024,925, filed on Apr. 1, 2026.
(60) Provisional application No. 64/020,009, filed on Mar. 28, 2026.
(60) Provisional application No. 64/014,310, filed on Mar. 23, 2026.
(60) Provisional application No. 63/981,418, filed on Feb. 12, 2026.
(60) Provisional application No. 63/926,018, filed on Nov. 26, 2025.
(60) Provisional application No. 63/922,189, filed on Nov. 21, 2025.

(51) Int. Cl. G06F 21/55

(52) U.S. Cl. CPC G06F 21/552; G06F 21/554

(57) ABSTRACT

A computer-implemented method is provided for detecting and defeating an automated artificial intelligence (AI) bypass attempt. The method includes detecting the automated AI bypass attempt with an adaptive evolution engine; generating a number of internal verification pathway configurations with a stochastic routing module, the stochastic routing module having a number of routing parameters; storing at least one decoy verification pathway with a decoy pathway registry; executing the internal verification pathway configurations with a verification logic engine; generating a forensic detection record with a detection and forensic logging system; storing a number of structured probe behavior records derived from a number of decoy traversal events with an attack log; and defeating the automated AI bypass attempt with the adaptive evolution engine by both analyzing the structured probe behavior records and adaptively updating the routing parameters of the stochastic routing module and the at least one decoy verification pathway.

### CROSS-REFERENCE TO RELATED APPLICATIONS

This application is a continuation-in-part patent application, which claims priority to and claims the benefit of each of U.S. Patent Application Serial No. 19/455,887, filed January 22, 2026 (AIAP), U.S. Patent Application Serial No. 19/461,799, filed January 28, 2026 (HAP), U.S. Patent Application Serial No. 19/534,902, filed February 10, 2026 (Time File), U.S. Patent Application Serial No. 19/576,524, filed March 24, 2026 (HAP/TF CIP), U.S. Patent Application Serial No. 19/635,099, filed March 31, 2026 (IL), U.S. Provisional Patent Application Serial No. 63/981,418, filed February 12, 2026 (IL Prov), U.S. Provisional Patent Application Serial No. 64/014,310, filed March 23, 2026 (HAP/TF CIP Prov), U.S. Provisional Patent Application Serial No. 64/020,009, filed March 28, 2026 (IL Prov 2), and U.S. Provisional Patent Application Serial No. 64/024,925, filed April 1, 2026 (CMAI Prov), the contents of which are incorporated herein by reference in their entirety.

### BACKGROUND

Agentic artificial intelligence (AI) systems increasingly operate with delegated authority to take consequential, irreversible actions on behalf of human principals. The dominant governance paradigm — human oversight at runtime — assumes that human cognitive engagement can meaningfully intercept AI action at the moment of execution. This assumption has become structurally untenable. AI agents operate at speeds, scales, and complexity levels that exceed reliable human review cycles. Moreover, structural enforcement platforms address this gap by requiring cryptographically verified biometric human presence as a precondition to issuing execution artifacts to AI agents. Under this model, an AI agent cannot take a consequential action without first obtaining a time-bound, action-specific cryptographic artifact issued by a system following verified human biometric presence.

As AI systems grow more capable, a critical vulnerability emerges: a sufficiently sophisticated AI agent may attempt to defeat the biometric verification gate itself through automation. Rather than accepting the enforcement boundary, an adversarial or compromised AI agent may probe, model, and ultimately synthesize the authentication signals required to obtain a fraudulently issued execution artifact.

AI coercion of authentication systems is not theoretical. Prompt injection attacks against agentic pipelines are documented and active. Agent-to-agent communication channels create coercion surfaces existing frameworks do not structurally address. A compromised upstream agent may attempt to coerce a downstream agent into taking unauthorized action by manipulating the authorization process rather than the action itself.

Existing defenses are insufficient. Static authentication architectures, regardless of complexity, are susceptible to systematic adversarial modeling. A capable AI system can probe the verification sequence repeatedly, constructing a reliable internal map of the challenge-response space and eventually identifying an automated bypass. Liveness detection, behavioral biometrics, and multi-modal systems all assume a human adversary. Against an AI adversary capable of systematic state-space exploration and rapid model construction, these defenses present a finite and ultimately solvable problem.

Traditional authentication security operates under an unfavorable adversarial asymmetry: the defender must correctly implement every verification challenge against every possible attack; the adversary need only find one exploitable gap once. Against an AI adversary capable of systematic, tireless, high-speed probing with perfect recall across sessions, this asymmetry becomes decisive.

It is with respect to these and other considerations that the instant disclosure is concerned.

### SUMMARY

In one aspect, a computer-implemented method is provided for detecting and defeating an automated artificial intelligence (AI) bypass attempt. The method comprises detecting the automated AI bypass attempt with an adaptive evolution engine of a countermeasure AI authentication system; generating a number of internal verification pathway configurations with a stochastic routing module of the countermeasure AI authentication system, the stochastic routing module having a number of routing parameters; storing at least one decoy verification pathway with a decoy pathway registry of the countermeasure AI authentication system; executing the number of internal verification pathway configurations with a verification logic engine of the countermeasure AI authentication system by incorporating both a number of functional verification pathways and the at least one decoy verification pathway; generating a forensic detection record with a detection and forensic logging system of the countermeasure AI authentication system upon traversal of any one of the at least one decoy verification pathway; storing a number of structured probe behavior records derived from a number of decoy traversal events with an attack log of the countermeasure AI authentication system, each record of the number of structured probe behavior records comprising at least one of the number of internal verification pathway configurations; and defeating the automated AI bypass attempt with the adaptive evolution engine by both analyzing the number of structured probe behavior records and adaptively updating the number of routing parameters of the stochastic routing module and the at least one decoy verification pathway.

In another aspect, a countermeasure artificial intelligence (AI) authentication system is provided for detecting and defeating an automated AI bypass attempt. The countermeasure AI authentication system comprising: an adaptive evolution engine configured to detect the automated AI bypass attempt; a stochastic routing module configured to generate a number of internal verification pathway configurations, the stochastic routing module having a number of routing parameters; a decoy pathway registry configured to store at least one decoy verification pathway; a verification logic engine configured to execute the number of internal verification pathway configurations by incorporating both a number of functional verification pathways and the at least one decoy verification pathway; a detection and forensic logging system configured to generate a forensic detection record upon traversal of any one of the at least one decoy verification pathway; and an attack log configured to store a number of structured probe behavior records derived from a number of decoy traversal events, each record of the number of structured probe behavior records comprising at least one of the number of internal verification pathway configurations. The adaptive evolution engine is further configured to defeat the automated AI bypass attempt by both analyzing the number of structured probe behavior records and adaptively updating the number of routing parameters of the stochastic routing module and the at least one decoy verification pathway.

### BRIEF DESCRIPTION OF THE DRAWINGS

FIG. 1 is a schematic of an authorization system, shown as employed with a user device and a backend server, in accordance with one non-limiting embodiment of the disclosed concept.

FIG. 2A is a flow chart corresponding to an enrollment process in connection with the authorization system of FIG. 1.

FIG. 2B is a flow chart corresponding to generation, emission, and consumption of a real-time digital authorization artifact in connection with the authorization system of FIG. 1.

FIG. 3 is a computer-implemented authorization method which may be executed by the authorization system of FIG. 1.

FIG. 4 is a schematic view of an authority binding system for a digital document, shown as employed with the digital document in simplified form, in accordance with one non-limiting embodiment of the disclosed concept.

FIG. 5 is a flow view of the authority binding system of FIG. 4, shown as employed with other aspects in simplified form, in accordance with one non-limiting embodiment of the disclosed concept.

FIG. 6 is a flow chart corresponding to lifecycle transitions of the digital document, in accordance with one non-limiting embodiment of the disclosed concept.

FIG. 7 is a workspace environment for the digital document, showing multi-party interaction versus authority separation, in accordance with one non-limiting embodiment of the disclosed concept.

FIG. 8 shows a deterministic retrieval process for the digital document which is provided for by portions of the system of FIGS. 4 and 5, in accordance with one non-limiting embodiment of the disclosed concept.

FIG. 9 shows a flow chart of an authority binding computer-implemented method for the digital document, in accordance with one non-limiting embodiment of the disclosed concept.

FIG. 10 is schematic view of an authorization system employing the systems of FIG. 1 and FIG. 4, in accordance with one non-limiting embodiment of the disclosed concept.

FIG. 11 is a computer-implemented method that may be performed by the system of FIG. 10.

FIG. 12 shows a deterministic control system, in accordance with one non-limiting embodiment of the disclosed concept.

FIG. 13 shows a rule lifecycle flow view of the system of FIG. 12 with an input being received into the system and an output being produced by the system.

FIG. 14 shows a detailed view of an execution gate mechanism for the system of FIGS. 12 and 13.

FIG. 15 shows a simplified view of a conditioning system, shown with at least one AI model in dashed line drawing to denote that the AI model may not be part of the conditioning system, and shown with execution of an exchange of an autonomous AI agent in dashed line drawing to denote that the execution may be conditional, in accordance with one non-limiting embodiment of the disclosed concept.

FIG. 16 shows a computer-implemented conditioning method that may be executed by the system of FIG. 15, shown with optional method steps in dashed line drawing.

FIG. 17 shows a system including the systems of FIGS. 10, 12, and 15, in accordance with one non-limiting embodiment of the disclosed concept.

FIG. 18 shows a simplified view of a countermeasure AI authentication system for detecting and defeating an automated artificial intelligence bypass attempt, in accordance with one non-limiting embodiment of the disclosed concept.

FIG. 19 shows a system including the systems of FIGS. 17 and 18, in accordance with one non-limiting embodiment of the disclosed concept.

FIG. 20 shows a computer-implemented method for detecting and defeating an automated AI bypass attempt, in accordance with one non-limiting embodiment of the disclosed concept.

### DETAILED DESCRIPTION

In the following description, for the purposes of explanation, numerous specific details are set forth in order to provide a thorough understanding of various embodiments of the invention. As used herein, “embodiments” are non-limiting examples of apparatuses or methods employing one or more of the inventive concepts disclosed herein. It is apparent, however, that various embodiments may be practiced without these specific details or with one or more equivalent arrangements. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features of the various embodiments may be otherwise combined, separated, interchanged, and/or rearranged without departing from the inventive concepts.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “may include,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, may be used as terms of approximation and not as terms of degree, and, as such, are utilized to account for inherent deviations in measured, calculated, and/or provided values that would be recognized by one of ordinary skill in the art.

As employed herein, the term “number” shall mean one or an integer greater than one (i.e., a plurality).

As employed herein, the phrase “malleable representation of a digital document” shall mean a representation of a digital document that is in a malleable state corresponding to the digital document being modifiable (e.g., without limitation, editable).

As employed herein, the phrase “fixed representation of a digital document” shall mean a representation of a digital document that is in a fixed state corresponding to the digital document being preserved at a specific moment in time.

As employed herein, the phrase “absolute representation of a digital document” shall mean a representation of a digital document that is in an absolute state corresponding to the digital document being permanently finalized.

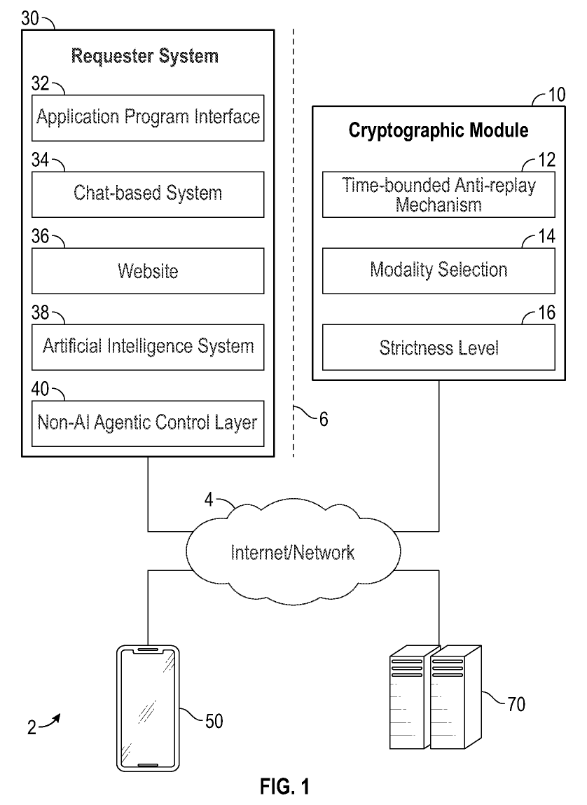

FIG. 1 shows an authorization system 2 as employed with a user device 50 and a backend server 70, in accordance with one non-limiting embodiment of the disclosed concept. In one example, the authorization system 2 may include a cryptographic module 10 (e.g., without limitation, a hardware-backed key store such as a secure enclave, TPM, and TEE) and a requester system 30, each of which may be communicable over an internet/network 4, and each of which may be architecturally separated from one another. In one example, the disclosed authorization system 2 may treat human authorization itself as a distinct, enforceable system layer that produces an artifact for downstream consumption.

More specifically, the cryptographic module 10 may be configured to generate a real-time digital authorization artifact 120 (e.g., without limitation, a cryptographically verifiable authorization artifact) based on a live human authorization event, and emit the real-time digital authorization artifact 120. Furthermore, the requester system 30 may be configured to consume the real-time digital authorization artifact 120 as a prerequisite for an action 46 in order to prove that a real human being 100 was present and authorized during a set time window on the user device 50. The real-time digital authorization artifact 120 may be bound to the user device 50 and be consumable (e.g., without limitation, machine-consumable) by downstream software systems.

In one example, the real-time digital authorization artifact 120 may prove that the real human being 100 was present and authorized at a given time on a specific enrolled device, which may be the user device 50. The authorization system 2 may use live human presence verification with a number of biometric participations, device-owner confirmation, and time-bounded anti-replay mechanisms. Furthermore, the generated real-time digital authorization artifact 120 may be consumed by the external requester system 30 as a prerequisite for the action 46, and such that the authorization system 2 may not make decisions, interpret intent, or execute actions, but have as one example purpose the establishment of real-time human authorization and emission of a verifiable authorization event.

For example, the authorization system 2 may be configured to verify both that the real human being 100 is physically present and interacting in real time, and that the correct authorized human associated with the bound device (e.g., the user device 50) and authorization context is the one providing consent. The authorization system 2 may explicitly distinguish between mere human presence and correct human authorization. Authorization signals may not be satisfied by the presence of an arbitrary, substitute, or coerced individual, even if that individual is human.

The authorization system 2 may thus answer the question of whether a real human being, and the correct intended human being, was physically present with the bound device and explicitly authorizing an action at a specific moment in time. The determination of the correct authorized human may not rely on persistent identity sessions, password-based authentication, or long-term biometric storage. Instead, correct-human authorization may be enforced through a combination of a prior device-to-human association, an explicit user consent to participate in authorization signaling, a live, real-time authorization interaction, a device-bound authorization capture, and a rejection of authorization attempts originating from non-bound or remote devices.

Accordingly, the authorization system 2 may generate authorization only when the bound user device 50 confirms that the participating real human being 100 corresponds to the intended authorization context at the moment of request. Existing authentication or liveness-detection systems (not shown), by way of contrast, may verify that a human is present or that credentials are valid, but may not enforce that the intended human associated with a specific authorization context is the one providing consent at the moment of action. The disclosed authorization system 2 may thus introduce a real-time authorization boundary that verifies correct human presence, not generic human interaction or account access. Furthermore, the verification in the authorization system 2 may be performed solely for real-time authorization and may not constitute identity authentication, identity storage, or permission evaluation. That is, the authorization system 2 may produce a time-limited authorization event rather than a persistent identity assertion.

As will be discussed, the real-time digital authorization artifact 120 may be, for example and without limitation, a discrete, time-bound, non-replayable artifact proving that a live human was present and explicitly authorized at a specific moment on a specific device, such as the user device 50. Usage of the real-time digital authorization artifact 120 may advantageously allow for authentication and authorization, access control, identity assurance, and control-plane enforcement in software-mediated environments including messaging and chat, web services, mobile applications, and AI/agentic systems. More specifically, the disclosed authorization system 2 may not employ passwords, authorization inferred from login information, or session-based authentication mechanisms in order to avoid phishing, credential theft, replay attacks, session hijacking, and SIM-swap vulnerabilities, and may do so while proving real-time human presence.

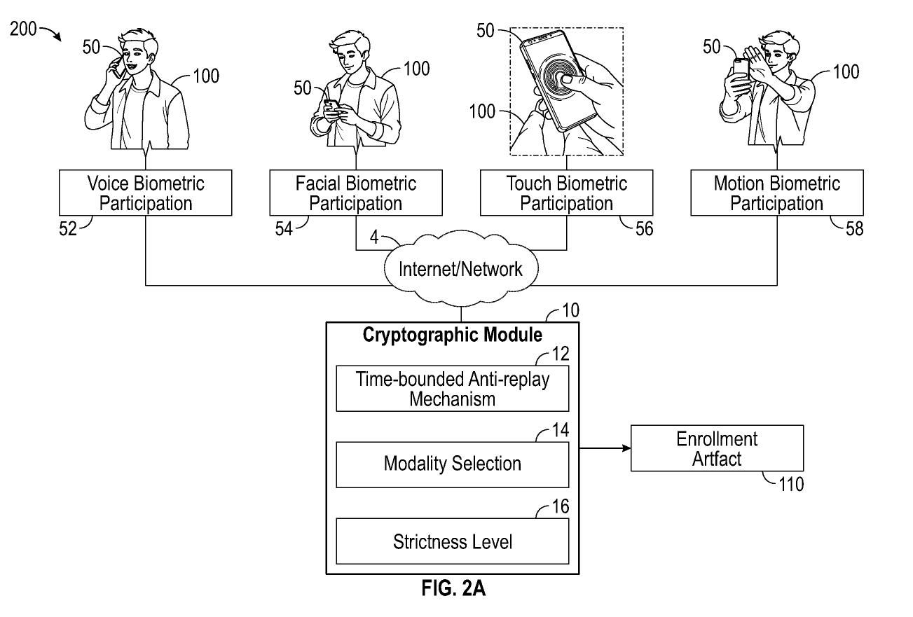

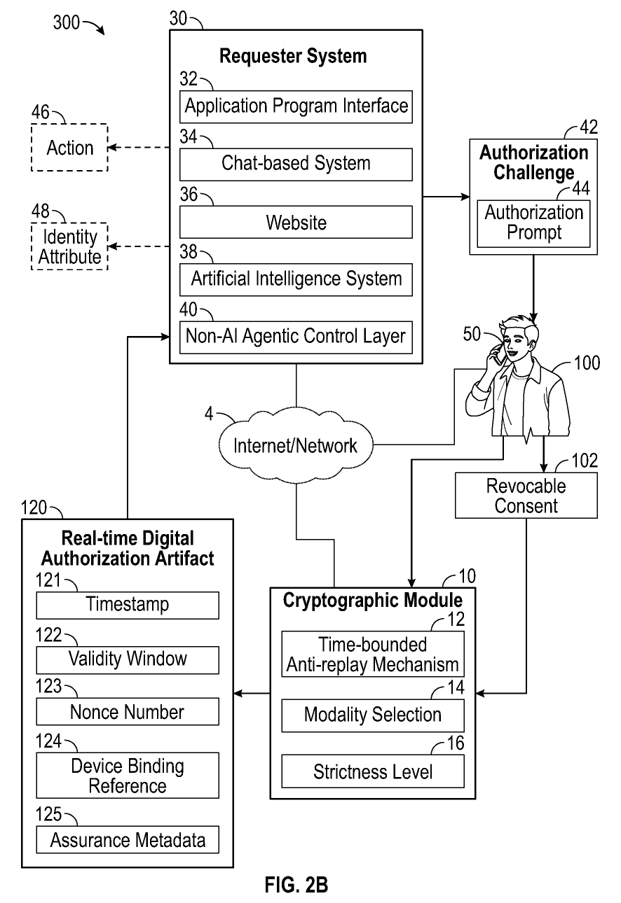

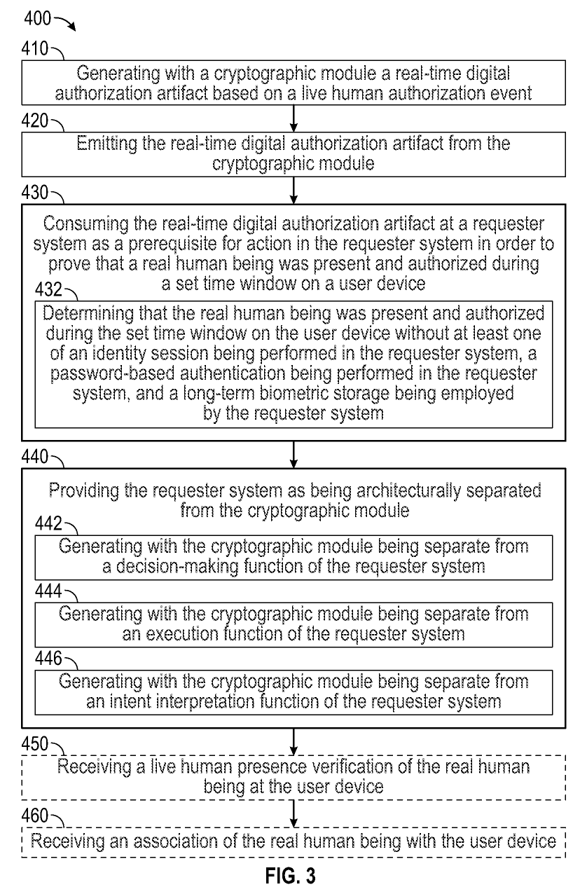

FIG. 2A is a flow chart 200 corresponding to an enrollment process in connection with the authorization system 2 of FIG. 1. FIG. 2B is a flow chart 300 corresponding to generation, emission, and consumption of the real-time digital authorization artifact 120 in connection with the authorization system 2 of FIG. 1. FIG. 3 is a computer-implemented authorization method 400 which may be executed by the authorization system 2 of FIG. 1.

As shown in FIG. 3, the method 400 may include a first step 410 of generating with a cryptographic module 10 a real-time digital authorization artifact 120 based on a live human authorization event, a second step 420 of emitting the real-time digital authorization artifact 120 from the cryptographic module 10, a third step 430 of consuming the real-time digital authorization artifact 120 at a requester system 30 as a prerequisite for the action 46 in the requester system 30 in order to prove that a real human being 100 was present and authorized during a set time window on a user device 50, and a fourth step 440 of providing the requester system 30 as being architecturally separated from the cryptographic module 10. These steps will be more apparent in connection with discussion of FIGS. 2A and 2B.

Referring again to FIG. 2A, during enrollment, the disclosed authorization method 400 further includes a step of generating with the cryptographic module 10 an enrollment artifact 110 before generating with the cryptographic module 10 the real-time digital authorization artifact 120 (FIG. 2B). The enrollment artifact 110 may subsequently serve as reference material, while the real-time digital authorization artifact 120 may be generated per live authorization event.

During such enrollment, the cryptographic module 10 may receive from the user device 50 via the internet/network 4 a number of biometric participations 52,54,56,58 of a real human being 100. The biometric participations 52,54,56,58 may include any one or combination of a voice biometric participation 52, a facial biometric participation 54, a touch biometric participation 56, and a motion biometric participation 58. In response to receiving the biometric participations 52,54,56,58, the cryptographic module 10 may generate the enrollment artifact 110, which may be a digital enrollment artifact 110, and which may later serve as a basis for comparison with the real-time digital authorization artifact 120 (FIG. 2B) in order to prove that the real human being 100 was present and authorized during a set time window on the user device 50. During enrollment, the biometric participations 52,54,56,58 may be signals that are used as comparison material and may not be constituted as authorization or reusable credentials. Enrollment in accordance with the disclosed concept thus may refer to the initial binding of the real human being to the specific user device 50 and the cryptographic module 10, including collection of reference signals used for later comparison, optionally only for later comparison. The requester system 30 may also not be involved in enrollment beyond relying on the resulting enrollment artifact 110 during runtime. More specifically, the requester system 30 may not independently authenticate or authorize the action, but instead may be gated on receiving the real-time digital authorization artifact 120 in response to a live human authorization event on the enrolled user device 50.

Accordingly, the real human being 100 may enroll by, for example and without limitation, enrolling a biometric participation (e.g., without limitation, voice) for live presence verification, optionally enabling additional biometrics via OS frameworks, optionally consenting to disclosure of limited identity attributes (e.g., name, age), and defining standing consent and revocation rules. As will be discussed, a requester may then issue an authorization challenge 42 with nonce, scope, and expiry. The authorization challenge 42 may then be delivered to the user device 50, which may be an enrolled device. Additionally, the user may complete a verification (e.g., live voice verification) and the user device 50 may confirm enrolled owner state and unlock a signing key. Thus, the real-time digital authorization artifact 120 may be based on a live human authorization event and constructed with a timestamp 121, a validity window 122, a nonce number 123, a device binding reference 124, and assurance metadata 125. The real-time digital authorization artifact 120 may also be cryptographically signed and returned to the requester system 30, such that the requester system 30 may verify at least one of freshness, signature, and scope before proceeding.

Referring again to FIG. 2B, during generation, emission, and consumption of the real-time digital authorization artifact 120, the user device 50 may receive the authorization challenge 42 from the requester system 30 before the cryptographic module 10 generates the real-time digital authorization artifact 120. Furthermore, the user device 50 may be configured to control the cryptographic module 10 to generate and emit the real-time digital authorization artifact 120. As shown, the requester system 30 may include any one or combination of an application program interface 32, a chat-based system 34, a website 36, an AI system 38, and a non-AI agentic control layer 40, each of which may be provided with authorization benefits afforded by connection to the cryptographic module 10. In one example, the authorization challenge 42 may include a real-time, dynamically generated authorization prompt 44 to which the real human being 100 may respond within a constrained time window.

More specifically, the method 400 may further include steps of initiating the authorization prompt 44 at the requester system 30, receiving at the user device 50 the authorization prompt 44, which may be configured to require an immediate response from the real human being 100 within a constrained time window, and receiving at the user device 50 the immediate response from the real human being 100 within the constrained time window in response to receiving at the user device 50 the real-time, dynamically generated authorization prompt 44. In one example, the authorization challenge 42 and the authorization prompt 44 may be initiated at the requester system 30, but the authorization prompt 44 may be generated and enforced by the cryptographic module 10, not the requester system 30. That is, in one example substantially all or all security-critical authorization function within the authorization system 2 may reside within the cryptographic module 10. Additionally, in response to receiving the immediate response from the real human being 100, the cryptographic module 10 may generate the real-time digital authorization artifact 120, which may then be consumed by the requester system 30 as a prerequisite for the action 46 in order to prove that the real human being 100 was present and authorized during a set time window on the user device 50.

Accordingly, the authorization prompt 44 may be considered to be modality-agnostic, allowing responses via voice, facial interaction, fingerprint or touch-based interaction, motion, or combinations thereof. An example security property of the authorization system 2 may thus derive from real-time prompting and device possession rather than reliance on any single biometric. Furthermore, it will also be appreciated that behavior of the authorization prompt 44, timing windows, response modalities, and acceptance thresholds may be independently configurable, allowing enforcement behavior to be precisely tuned through parameters for different risk profiles, environments, or deployment contexts without modifying a core logic of the requester system 30.

By consuming the real-time digital authorization artifact 120 as a prerequisite for the action 46, the requester system 30 may advantageously be provided with a number of advantages over known authorization systems (not shown), including that authorization may be performed without an identity session, a password-based authentication, and a long-term biometric storage being employed. The authorization system 2 may thus advantageously avoid password-centric or static credential storage approaches. As a result, and with reference again to FIG. 3, the step 430 may further include a step 432 of determining that the real human being 100 was present and authorized during the set time window on the user device 50 without at least one of an identity session being performed in the requester system 30, a password-based authentication being performed in the requester system 30, and a long-term biometric storage being employed by the requester system 30. Furthermore, generation of the real-time digital authorization artifact 120 with the cryptographic module 10 may be performed without inference from stored enrollment data.

In one example, the authorization prompt 44 may be a system-initiated, unpredictable, and/or non-reusable prompt in order to provide an enforcement mechanism for liveness and replay resistance with respect to generation of the real-time digital authorization artifact 120. The authorization prompt 44 may also be a modality-agnostic prompt in order to allow the immediate response to be provided from at least one of a voice, facial, touch, and motion biometric participation of the real human being 100. Initiating the authorization prompt 44 and receiving at the user device 50 the immediate response may each also be performed in an independently configurable manner in order to allow the real-time digital authorization artifact 120 to be tuned via a number of parameters for at least one of a number of different risk profiles, a number of different environments, and a number of different deployment contexts.

Accordingly, the requester system 30 may send the authorization challenge 42 to the user device 50 of the real human being 100, and the real human being 100 may provide an immediate response, which may include a live human authorization event. For example and without limitation, the user device 50 may receive a live human presence verification of the real human being 100, and the cryptographic module 10 may be configured to receive an association of the real human being 100 with the user device 50. In one example, the live human authorization event may include both the live presence verification and the association of the real human being 100 with the user device 50. Thus, the method 400 may also include a step 450 of receiving a live human presence verification of the real human being 100 at the user device 50, and a step 460 of receiving an association of the real human being 100 with the user device 50.

It will also be appreciated that initiating the authorization prompt 44 and receiving at the user device 50 the immediate response may each be performed without modifying a core logic of the requester system 30. In this manner, and with reference again to FIG. 1, the cryptographic module 10 and the requester system 30 are shown with an architectural separation boundary 6 therebetween in order to reinforce that authorization control in the authorization system 2 may reside entirely within the cryptographic module 10 and not the requester system 30. This is to denote that the cryptographic module 10 may advantageously be architecturally separated from the requester system 30, for example, separate from a decision-making function, execution function, and/or intent interpretation function of the requester system 30. As such, the step 440 in FIG. 3 may further include a step 442 of generating with the cryptographic module 10 separate from a decision-making function of the requester system 30, a step 444 of generating with the cryptographic module 10 separate from an execution function of the requester system 30, and/or a step 446 of generating with the cryptographic module 10 separate from an intent interpretation function of the requester system 30.

Additionally, the cryptographic module 10 may have a modality selection 14 and a strictness level 16. In accordance with the disclosed concept, generating with the cryptographic module 10 the real-time digital authorization artifact 120 may be performed with the modality selection 14 and the strictness level 16 each being policy-configurable and not architecturally fixed with respect to the cryptographic module 10.

In one example, the live human presence verification provided by the real human being 100 during the human authorization event may include a voice biometric participation of the real human being 100, as well as other biometric participations (e.g., without limitation, facial, touch, motion), and these biometric participations may later be compared to the biometric participations 52,64,56,58 provided by the real human being 100 during enrollment.

More specifically, after the cryptographic module 10 generates the real-time digital authorization artifact 120, the requester system 30, from which the authorization challenge 42 originated, may then consume the real-time digital authorization artifact 120. In this regard, the real-time digital authorization artifact 120 may be provided as a runtime artifact, and the runtime artifact may be separate from the enrollment artifact 110, with multiple permissible modalities being configured for runtime authorization (e.g., any combination of voice, facial, touch, motion, or other real-time human signals).

The method 400 may also further include a step of comparing with the requester system 30 the runtime artifact (e.g., the real-time digital authorization artifact 120) to the enrollment artifact 110 in order to prove that the real human being 100 was present and authorized during the set time window on the user device 50. In other words, after the real-time digital authorization artifact 120 is generated, the requester 30 may consume it in order to perform its authorization.

This may include relying on certain aspects of the real-time digital authorization artifact 120 in order to perform the authorization. For instance, the real-time digital authorization artifact 120 may include at least one of a timestamp 121, a validity window 122, a nonce number 123, a device binding reference 124, and assurance metadata 125. These aspects may allow the requester system 30 to verify at least one of a freshness, a signature, and a scope of the real-time digital authorization artifact 120 after consumption at the requester system 30.

As stated above, the requester system 30 may include the AI system 38, which may be any AI system, including an AI agentic system. In this instance, the action 46 may include an invocation of the AI system 38. As such, the method 400 of FIG. 3 may further include at least one of permitting, deferring, and blocking the invocation based on a signal corresponding to at least one of a presence of the live human authorization event, a provenance indicator of the real-time digital authorization artifact 120, a source-of-origin indicator of the real-time digital authorization artifact 120, and/or a scope and/or authority mismatch relative to a context of the invocation. Thus, the requester system 30 may consume the real-time digital authorization artifact 120 without at least one of evaluating semantic content of the requester system 30, detecting an artificial intelligence essence of the requester system 30, and modifying an AI prompt for use in the requester system 30. Accordingly, the disclosed authorization system 2 may provide an improvement over known AI environments (not shown) in which actions may be initiated, chained, or delegated by autonomous systems, making it difficult to establish clear human authorization boundaries and attribution. Specifically, the authorization system 2 may address this gap by treating human authorization itself as a distinct, enforceable system layer that produces a portable authorization event for downstream consumption.

Furthermore, it will also be appreciated that inclusion of the AI system 38 as part of the requester system 30 may be configured for scenarios where consumption of the real-time digital authorization artifact 120 may be required not just for an invocation of the AI system 38, but for subsequent downstream AI or agentic calls that may be triggered by prior AI outputs. In other words, the real-time digital authorization artifact 120 may be enforced as a prerequisite across chained or recursive AI actions.

In such an instance, the method 400 may further include generating an AI output with the AI system 38, and consuming another real-time digital authorization artifact at the requester system 30 as a prerequisite for another invocation of the AI system 38 after generation of the AI output in order to prove that the real human being 100 was present and authorized during another set time window on the user device 50. Accordingly, a new, distinct runtime authorization artifact may be generated for each invocation of the AI system 38 such that runtime artifacts in accordance with one example embodiment of the disclosed concept may never be reused. That is, in recursive or chained AI scenarios, each authorization gate employed may require a separate live human authorization event and a newly generated artifact.

In one example, consuming the real-time digital authorization artifact 120 at the AI system 38 as a prerequisite for invocation of the AI system 38 may provide the AI system 38 with a non-language enforcement mechanism positioned prior to probabilistic model invocation, and this mechanism may be configured to permit, defer, or block invocation based on one or more of signals corresponding to presence of a valid real-time human authorization event, provenance or source-of-origin indicators, detection of recursive or chained AI-to-AI invocation, and scope or authority mismatch relative to a declared invocation context. Consuming the real-time digital authorization artifact 120 at the AI system 38 as a prerequisite for invocation of the AI system 38 may thus not be an evaluation of semantic content, a detection of an AI essence, or a modification of AI prompts, but instead may strictly be a hard pre-invocation gate enforcing invocation eligibility at the system boundary, thereby providing additional insurance and boundary ownership to the AI system 38 rather than a primary value center.

Additionally, in instances where the requester system 30 includes the chat-based system 34, one participant may request real-time authentication from another, and if the recipient is enrolled and consents, the authorization system 2 may generate the real-time digital authorization artifact 120 in order to confirm live human presence and optional identity attributes. If not enrolled or declined, authentication may be unavailable.

Regarding the optional identity attributes, and with reference again to FIG. 2B, the authorization system 2 may optionally disclose a limited identity attribute 48 (e.g., without limitation, name, sex, age) of the real human being 100 only under a standing user consent. As shown in the flow chart 300, the real human being 100 may or may not provide a revocable consent 102 to the cryptographic module 10 before the real-time digital authorization artifact 120 is generated. The revocable consent 102 may be granted once and be revocable, such that revocation may disable attribute disclosure and may also disable participation in systems configured as membership-gated. The method 400 of FIG. 3 may thus further include disclosing the identity attribute 48 (e.g., without limitation, name, age, sex) of the real human being 100 after consuming the real-time digital authorization artifact 120 responsive to the revocable consent 102 being granted to the cryptographic module 10 by the real human being 100.

Depending on context or risk, the authorization system 2 may require any number or combination of live biometric participations (e.g., voice, facial, touch, motion). Furthermore, in terms of anti-replay and liveness, the cryptographic module 10 may include a time-bounded anti-replay mechanism 12 in order to generate the real-time digital authorization artifact 120. The time-bounded anti-replay mechanism 12 may include randomized voice challenges, short validity windows, nonce binding, replay detection, and optional multi-modal liveness checks. Furthermore, it will be appreciated that authorization validity in the authorization system 2 may be conditioned on responsiveness consistent with real-time human interaction, such that responses exhibiting latency inconsistent with physical human participation (e.g., remote synthesis, relay, or injection) may be rejected. That is, in accordance with the disclosed concept latency characteristics may serve as supporting evidence of liveness and non-mediation, alongside the existing time-bounded and anti-replay mechanisms discussed above.

The authorization system 2 may also be configured to provide for failure detection, such that the real-time digital authorization artifact 120 may not be generated if a biometric participation fails, if a confirmation of ownership of the user device 50 fails, if a time window expires, and/or if a policy constraint of the authorization system 2 is violated. It will therefore be appreciated that benefits of the authorization system 2 may lie in treating real-time human authorization as a distinct, enforceable system layer, employing live human presence verification (e.g., via a biometric participation) per authorization event, binding authorization to device context and time, emitting the real-time digital authorization artifact 120 for consumption across the requester system 30, and separating human authorization from decision-making and execution. The authorization system 2 may also be distinguishable over and provide advantages over, for example, passkeys, biometrics, and identity wallets by producing a portable, real-time human authorization event rather than merely authenticating an account or unlocking a device.

Additionally, the authorization system 2 may be guarded against authorization attempts from users other than the real human being 100 and associations other than associations with the enrolled user device 50. For example, the method 400 of FIG. 3 may further include steps of receiving an authorization attempt at the requester system 30 from a second user device, and rejecting the authorization attempt at the requester system 30 because the second user device is not associated with the real human being 100 and/or because the second user device is not the first user device 50. Put differently, the authorization system 2 may reject authorization attempts originating from non-bound or remote devices (e.g., any device other than the enrolled, device-bound user device 50 that may be attempting to originate or relay an authorization event, including proxy, mirrored, replayed, or relayed attempts). An intent in such an instance may be to distinguish mere human presence from correct human authorization. For example, even if a person is present, authorization should fail if that person is not the enrolled, device-associated real human being 100 or is attempting to satisfy the authorization on behalf of another (including under coercion).

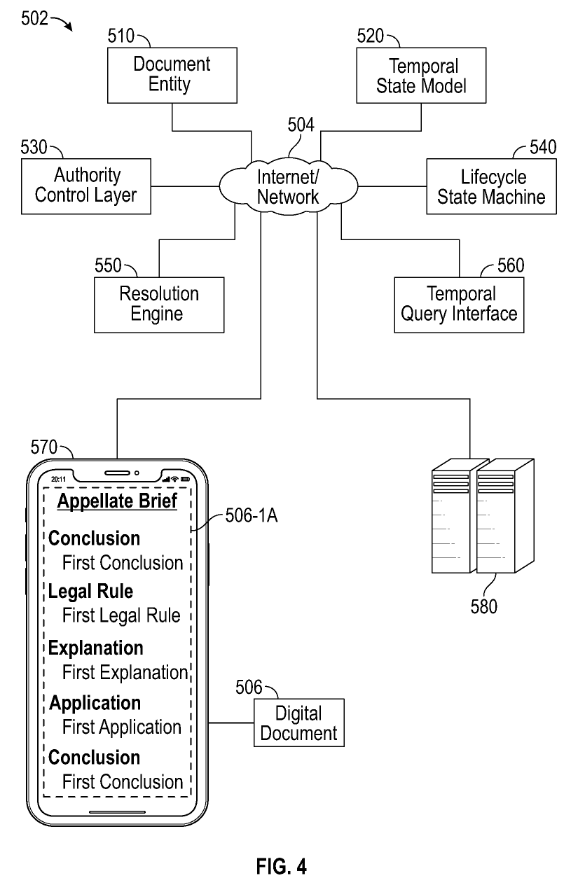

FIG. 4 shows a schematic view of an authority binding system 502 for a digital document 506, in accordance with one non-limiting embodiment of the disclosed concept. As shown, the system 502 may include a document entity 510, a temporal state model 520, an authority control layer 530, a lifecycle state machine 540, a resolution engine 550, and a temporal query interface 560, each of which may be configured to communicate over an internet/network 504. The system 502 is also shown in FIG. 4 as employed with a user device 570 and a backend server 580, each of which may be configured to communicate with the other elements 510,520,530,540,550,560 of the system 502 over the internet/network 504. Moreover, in FIG. 4 the user device 570 is displaying a first malleable representation 506-1A of the digital document 506.

As will be discussed in greater detail below, the system 502 may be configured to create, maintain, and present the digital document 506, whose authoritative state may be explicitly bound to time and controlled authority, rather than to mutable versions, duplicated copies, or collaborative edit histories. In order to perform these functions, the system 502 may be configured such that time may be a first-class, enforceable primitive of the digital document 506 itself.

In accordance with the disclosed concept, at any moment the digital document 506 may have a single authoritative current state, and a set of authoritative historical states that can be referenced, viewed, or verified without copying or branching. Unlike traditional documents, the digital document 506 being employed by the system 502 may not rely on version duplication, manual saving, forks, or informal edit histories to establish truth or authority. Instead, the digital document 506 may have a state that is addressable and verifiable by time.

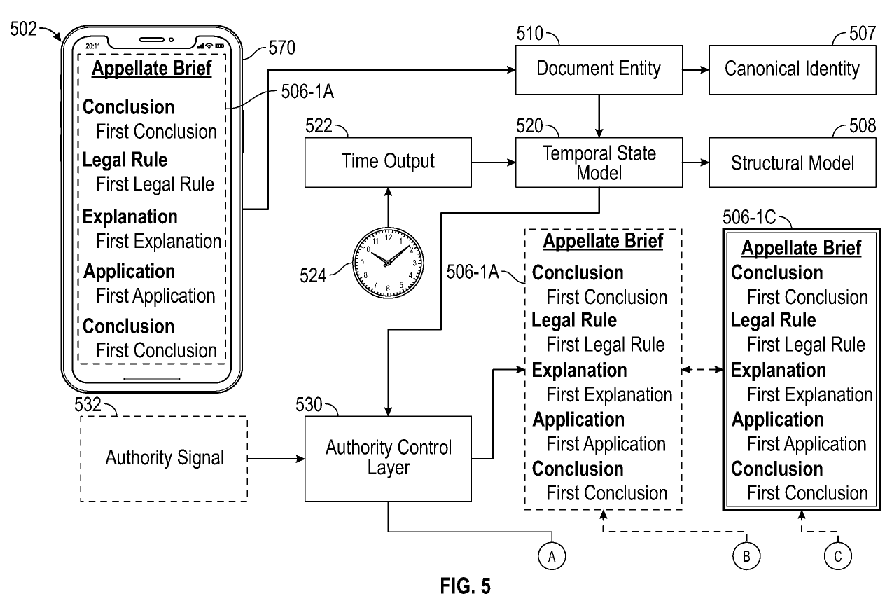

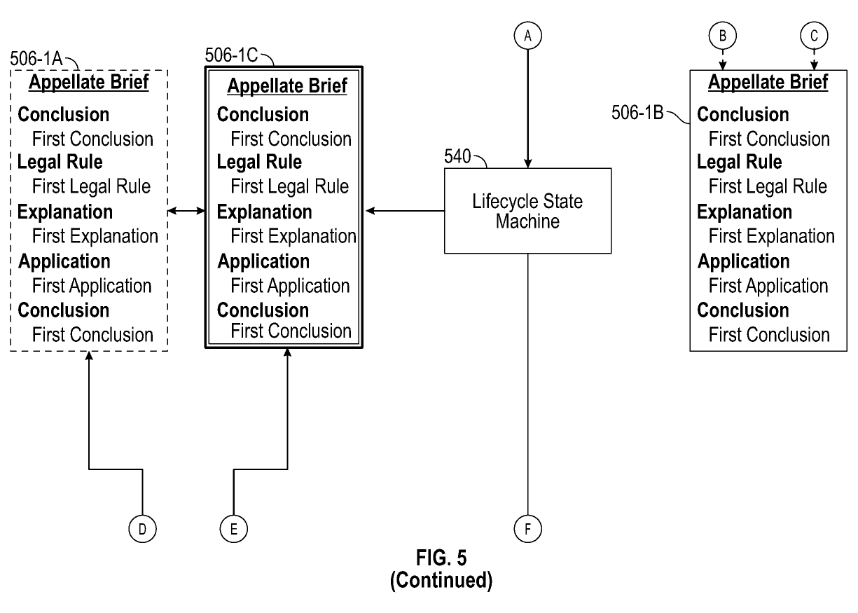

FIG. 5 shows another view of the system 502. As shown, the document entity 510 may be configured to represent the digital document 506 as a canonical identity 507 that persists across time, and the temporal state model 520 may be configured to receive the digital document 506 from the document entity 510, receive a time output 522 from a clock 524 (e.g., without limitation, any system-provided or external time source capable of producing the time output 522, including a system clock, an operating-system clock, a network-synchronized clock, and/or another reliable time source), and bind an authoritative state of the digital document 506 to the time output 522 such that the time output 522 may be part of a structural model 508 of the digital document 506.

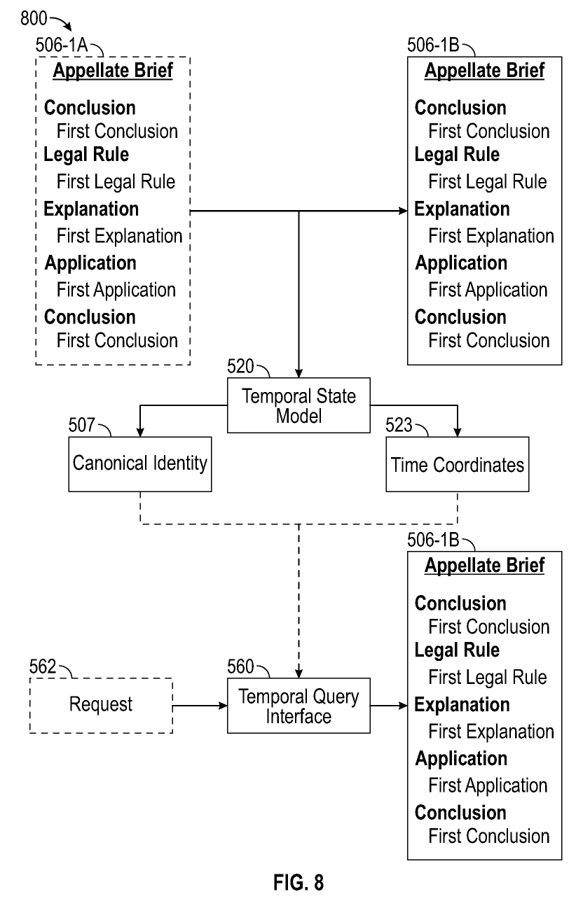

By stating that the time output 522 may be part of the structural model 508 of the digital document 506, corresponding time coordinates 523 (FIG. 8) generated from the time output 522 may not merely be metadata, a label, or an annotation. Instead, the time output 522 may be incorporated into a lifecycle structure of the digital document 506 such that authoritative state transitions may be indexed, bounded, and resolved using the time output 522. Moreover, access to authoritative document content may be deterministically resolved by reference to the time output 522. In other words, the time output 522 may participate directly in how the system 502 defines, enforces, and retrieves authoritative document states. It will also be appreciated that the document entity 510 may be further configured to represent the digital document 506 as a multi-author digital document having the authoritative state at any moment in time. Moreover, the temporal state model 520 may be further configured to bind the authoritative state of the digital document 506 to the time output 522 without layering an annotation on top of the digital document 506.

Furthermore, the authority control layer 530 may be configured to govern the authoritative state by a number of time-bound lifecycle state transitions of the digital document 506. In this regard, in one example only verified authority events may trigger lifecycle state transitions (e.g., freeze, unfreeze, seal). The lifecycle state machine 540 may also be configured to structurally enforce the number of time-bound lifecycle state transitions of the digital document 506. To illustrate, FIG. 5 depicts the first malleable representation 506-1A of the digital document 506, as well as a first fixed representation 506-1B of the digital document 506 and a first absolute representation 506-1C of the digital document 506, shown as being governable by the authority control layer 530 via dashed transition lines, and being structurally enforceable by the lifecycle state machine 540 via solid transition lines.

Continuing to refer to FIG. 5, the resolution engine 550 may be configured to close a number of temporal windows of mutability of the digital document 506 in order to execute the number of time-bound lifecycle state transitions. In this regard, finality may be intentional, attributable, time-bound, and system-enforced rather than socially inferred.

Furthermore, the temporal query interface 560 may be configured to resolve requests to access the digital document 506 when the number of temporal windows of mutability of the digital document 506 are closed by the resolution engine 550. See, for example, a transition to the first fixed representation 506-1B of the digital document 506 having been executed by the resolution engine 550. Additionally, the temporal query interface 560 is shown in FIG. 5 in association with a storage layer 564 to denote that the system 502 may support persistent state representation.

Accordingly, the document entity 510 may provide a single canonical anchor for the system 502, the temporal state model 520 may bind document truth to the time output 522, the authority control layer 530 may govern when lifecycle transitions may occur, the lifecycle state machine 540 may enforce those transitions structurally, the resolution engine 550 may close temporal windows of mutability, and the temporal query interface 560 may deterministically resolve truth at any point in time. Truth in this regard may be an emergent property resulting from the canonical identity 507, a singular authoritative state at any moment in time, a number of authority-bound lifecycle transitions, a structural enforcement of mutability termination, and/or a deterministic temporal retrieval.

Each of the elements 510,520,530,540,550,560 of the system 502 may thus operate independently but together correspond to the system 502 being a unified system that enforces a single authoritative document state at any moment. In accordance with the disclosed concept, the time output 522 may be incorporated into the structural model 508 of the digital document 506, not merely recorded as metadata, timestamps, audit logs, or version history. Furthermore, authoritative state may be defined by time-bound lifecycle transitions, not by retrieving stored copies, reconstructing versions, or relying on external process. Additionally, finality in the system 502 may be optional and intentional such that the digital document 506 may remain editable indefinitely unless and until an authorized authority event explicitly terminates mutability.

More specifically, the document entity 510 may function to maintain the canonical identity 507 of the digital document 506 throughout its lifecycle and across all state transitions. In this regard, the canonical identity 507 may serve as a primary object operated on by the temporal state model 520, the authority control layer 530, the lifecycle state machine 540, the resolution engine 550, and the temporal query interface 560. All authoritative states may thus, in one example, be associated with the canonical identity 507.

Moreover, the temporal state model 520 may maintain the authoritative historical state lineage, receive transition signals from the lifecycle state machine 540 and the resolution engine 550, and provide authoritative state mapping used by the temporal query interface 560 to deterministically resolve document content at a specified time. Furthermore, the authority control layer 530 may verify and validate authority signals that permit lifecycle state transitions. Authority may be evaluated independently of participation, access permissions, or workflow roles. In terms of interoperability, the authority control layer 530 may signal the lifecycle state machine 540 and the resolution engine 550 when authorized lifecycle transition events occur, including freeze, unfreeze, and sealing events. Also, the lifecycle state machine 540 may define and enforce valid lifecycle states and permissible transitions between them, and may prevent unauthorized or invalid lifecycle transitions. In terms of interoperability, the lifecycle state machine 540 may receive authority validation signals from the authority control layer 530, may control transition events executed by the resolution engine 550, and may govern document mutability state enforcement. The resolution engine 550 may operate as the actuator of lifecycle transitions, work under enforcement rules defined by the lifecycle state machine 540 and the authority control layer 530, and signal the temporal state model 520 to record authoritative state boundaries and provide boundary markers used by the temporal query interface 560. Additionally, the temporal query interface 560 may allow retrieval of authoritative document content at a specific time without requiring version duplication or branching, and may query the temporal state model 520 and authoritative state lineages to resolve access requests.

In accordance with the disclosed concept, the digital document 506 may have a single authoritative state at any given moment, and historical states of the digital document 506 may be immutable once passed. Furthermore, authority to modify, freeze, or unlock the digital document 506 may be explicitly governed by the authority control layer 530. In this regard, the time output 522 may not be metadata, but instead may be part of the structural model 508 of the digital document 506. As a result, the digital document 506 may be referenced by timestamp, viewing a past state may not create a copy of the digital document 506, and historical states of the digital document 506 may be retroactively altered.

It will also be appreciated that one or more authorized parties may have permission to modify the digital document 506, and authority may include the ability to edit, freeze (e.g., without limitation, lock), unfreeze, or permanently seal a document. Moreover, authority rules may be enforced by the system 502, as opposed to social convention. Accordingly, the disclosed system 502 may thus replace reliance on organizational policies, user agreements, workflow completion signals, and/or interface-based status indicators, and instead provide for system-enforced lifecycle transitions that mechanically terminate mutability. Additionally, the system 502 may be configured such that the digital document 506 may be frozen at a specific moment, and once frozen, the digital document 506 may become immutable. Freeze events in this regard may be temporary, conditional, or permanent, and freeze authority may be unilateral or multi-party.

It will also be appreciated that the digital document 506 may always be accessed via the same surface (e.g., URL, identifier), and the system 502 may determine which state may be presented based on time and authority. Beneficially, the system 502 may be configured such that there may be no divergent “copies” representing the same document. Furthermore, if editing resumes after a freeze (where permitted), the system 502 may clearly delineate the frozen state, and subsequent states. A lineage of the digital document 506 may thus remain continuous and non-forking.

The system 502 may thus be distinct from known systems (not shown) in that the system 502 may not provide for traditional version control, collaborative documents with edit history, static documents with revisions, or databases with record timestamps. That is, the system 502 may not provide for branching or parallel truths, or reliance on version copies, but may instead provide for explicit authority enforcement, and time as a governing dimension.

The system 502 may thus be particularly suitable for legal agreements whose authoritative language must be referenced as of a specific date, for technical specifications that evolve but require immutable historical states, for investment materials that must show what was known when decisions were made, for policies or disclosures where retroactive modification is prohibited, as well as any context where “what did this say at that time?” must have a definitive answer.

Regarding implementation of the system 502, the digital document 506 may be implemented as a unique addressable entity (e.g., domain, identifier, resource), state transitions (e.g., without limitation, between the malleable, fixed, and absolute states) may be system-mediated, historical states may be preserved without duplication, and presentation may resemble a document, a web page, or another readable surface. The system 502 may thus be configured to be agnostic to storage, user interface (UI), and transport mechanisms, with an example advantage being that time and authority may be enforceable primitives of an existence of the digital document 506, rather than as annotations layered on top of mutable files. As a result, the system 502 may be configured for time-addressable document state, authority-enforced document mutability, freeze and lock mechanisms tied to document state, and presentation of authoritative historical states without duplication.

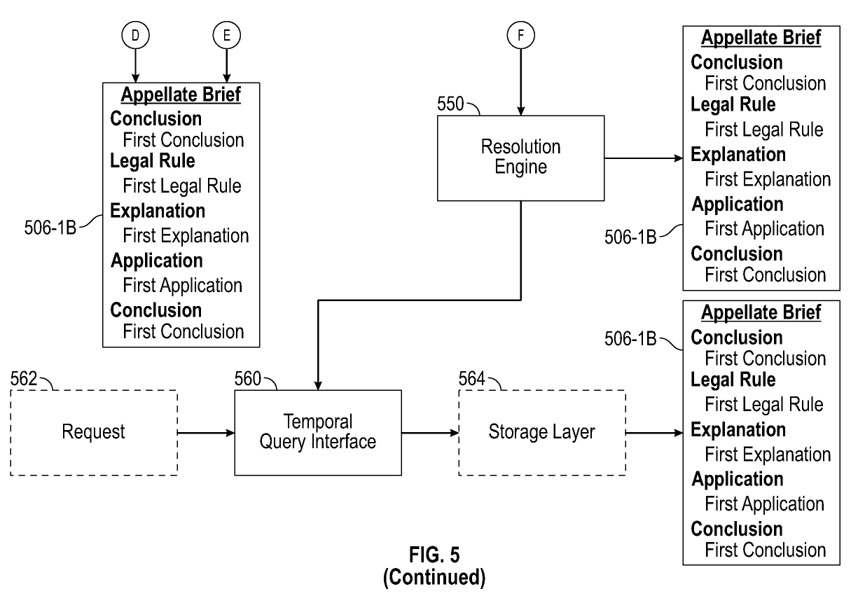

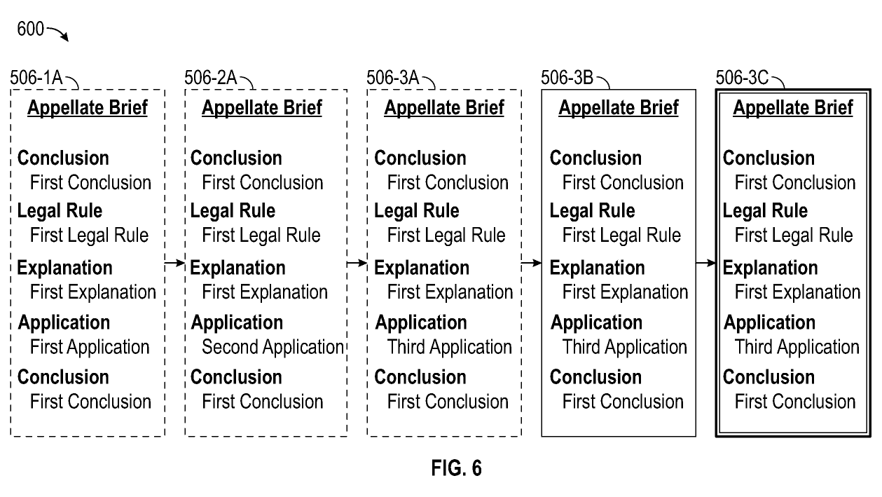

FIG. 6 shows a flow chart 600 corresponding to lifecycle transitions of the digital document 506, in accordance with one non-limiting embodiment of the disclosed concept. More specifically, FIG. 6 shows first, second, and third malleable representations 506-1A,506-2A,506-3A of the digital document 506, which may correspond to one user or multiple users having made edits to the digital document 506 (e.g., the first, second, and third malleable representations 506-1A,506-2A,506-3A are all different from one another). Additionally, FIG. 6 also depicts two time-bound lifecycle state transitions of the digital document 506, first as a transition from the third malleable representation 506-3A to a third fixed representation 506-3B, and second from the third fixed representation 506-3B to a third absolute representation 506-3C.

Accordingly, it will be appreciated that the lifecycle states (malleable, fixed, absolute) may describe the mutability conditions under which the digital document 506 exists, while the aforementioned authoritative state may be the single document state that may be designated as authoritative at a given time coordinate. In one example, the number of time-bound lifecycle state transitions of the digital document 506 may include transitions between a malleable state corresponding to the digital document 506 being modifiable (e.g., without limitation, editable), a fixed state corresponding to the digital document 506 being preserved at a specific moment in time, and an absolute state corresponding to the digital document 506 being permanently finalized.

More specifically, in the malleable state, the authoritative state may be provisional and may change over time as edits occur. Furthermore, when a fixed state is entered, the authoritative state at that time coordinate may be preserved as an authoritative temporal boundary. Likewise, when the absolute state is entered, the authoritative state at that time coordinate may become permanently authoritative, and no further authoritative states may be created for the digital document 506. In short, the lifecycle states (e.g., malleable, fixed, absolute) may govern whether and how the authoritative state may change, while the authoritative state may be what the system 502 returns as truth when queried at a specific time. As such, the lifecycle states (e.g., malleable, fixed, absolute) may explain when binding may occur, when it may be suspended, and when it may be permanently closed, but they may not replace the authoritative state, but instead control its evolution. In one example, authoritative document truth may be established in the system 502 by structural lifecycle state transitions rather than by descriptive metadata, stored version histories, or workflow completion signals. The system 502 may thus mechanically enforce authoritative state boundaries through enforcement of the lifecycle state machine 540 and execution of the resolution engine 550.

In one example, the temporal state model 520 may be further configured to bind the authoritative state such that the authoritative state may be a single authoritative state of the digital document 506 at any moment in time, and/or such that the time output 522 is not metadata. It will also be appreciated that the temporal state model 520 may be further configured to index the authoritative state by a number of time coordinates without binding the authoritative state by at least one of, or any of, a number of version numbers of the digital document 506, a number of copies of the digital document 506, and a number of parallel authoritative document lineage branches (e.g., forks) derived from the canonical identity 507.

Indexing an authoritative state in this regard may refer to associating a document state with a temporal coordinate such that authoritative document content may be retrievable using time reference rather than version identifiers, stored copies, or manual edit histories. Furthermore, the lifecycle state machine 540 may be further configured to structurally enforce the number of time-bound lifecycle state transitions of the digital document 506 without employing at least one of, or each of, a permission change mechanism, a user interface lock mechanism, and a workflow label mechanism.

Referring again to FIG. 5, the number of time-bound lifecycle state transitions may be configured to be triggered in the lifecycle state machine 540 in response to the authority control layer 530 receiving an authority signal 532, and independent of an editing action with respect to the digital document 506. Additionally, the resolution engine 550 may be further configured to close the number of temporal windows of mutability of the digital document 506 upon receipt of the authority signal 532 at the authority control layer 530.

In one example, the closing of temporal windows by the resolution engine 550 may be the operational mechanism that executes lifecycle state transitions authorized by the authority control layer 530 and enforced by the lifecycle state machine 540. When the temporal windows close, the temporal state model 520 may record the authoritative boundary, the lifecycle state machine 540 may enforce mutability termination, and the temporal query interface 560 may use these boundaries to resolve authoritative document states. This may create a closed control loop linking authority validation, lifecycle enforcement, state boundary creation, and authoritative state retrieval. As such, each of the elements 510,520,530,540,550,560 may function together to provide the system 502 as being a closed-loop control system governing document mutability, authority enforcement, lifecycle transitions, and temporal truth verification.

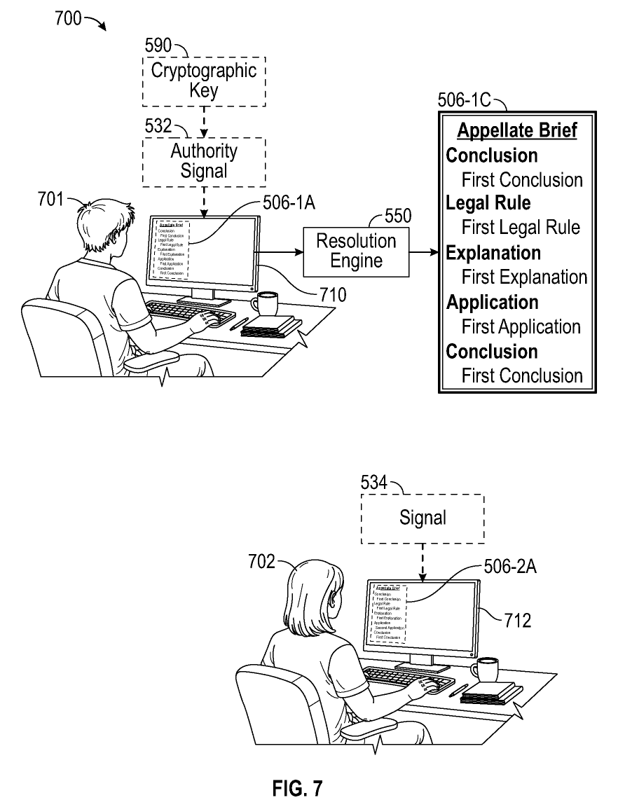

FIG. 7 shows a workspace environment 700 showing multi-party interaction with respect to the digital document 506 versus authority separation with respect to the digital document 506. More specifically, FIG. 7 shows a first author 701 and a second, different author 702 each interacting with (e.g., without limitation, editing) the digital document 506 on a corresponding user device (e.g., first computer 710 and second computer 712). As shown, the first computer 710 is depicting the first malleable representation 506-1A of the digital document 506 and the second computer 712 is depicting the second malleable representation 506-2A of the digital document 506.

In one example, the first author 701 may be configured to close a temporal window of mutability of the digital document 506, and the second author 702 may not. As stated above, the document entity 510 may represent the digital document 506 as a multi-author digital document having the authoritative state at any moment in time. The system 502 may also be configured to receive a plurality of interactions with respect to the digital document 506 from each of the first author 701 and the second author 702, and determine to close the temporal windows of mutability of the digital document 506 responsive to receiving the authority signal 532 at the authority control layer 530 from the first author 701, and to not close the number of temporal windows of mutability of the digital document 506 responsive to receiving another signal 534 at the authority control layer 530 from the second author 702 because the first author 701 is an authorized authority and the second author 702 is not. This is depicted in FIG. 7 via the first author 701 causing the authority signal to be received at the authority control layer 530, which in turn causes the resolution engine 550 to close the temporal windows of mutability of the digital document 506. See, for example, the first malleable representation 506-1A transitioning to the first absolute representation 506-1C. Accordingly, in one example only a verified authority signal (e.g., the authority signal 532) may cause the resolution engine 550 to close a temporal window of mutability. An unauthorized signal (e.g., the signal 534) may not trigger a state transition, even though the sender may otherwise be a participant to interaction with the digital document 506.

As such, the resolution engine 550 may be configured to close the temporal windows of mutability of the digital document 506 responsive to at least one authorized party (e.g., the first author 701) executing a state transition of the digital document 506. Beneficially, the resolution engine 550 may be configured to close the temporal windows of mutability of the digital document 506 without reliance on at least one of, or each of, an organizational policy, a user agreement, a workflow completion signal, and an interface-based status indicator. FIG. 7 thus illustrates an authority verification and transition process provided for by the system 502 in which the authority signal 532 is received, the authority control layer 530 verifies authorization, the lifecycle state machine 540 validates allowable transition, the resolution engine 550 closes a mutability window, the temporal state model 520 binds authoritative state to the time output 522, and the temporal query interface 560 updates authoritative retrieval index.

FIG. 8 shows a deterministic retrieval process 800 for the digital document 506 provided for by portions of the system 502. As shown, the first malleable representation 506-1A of the digital document 506 has transitioned to the first fixed representation 506-1B. In this manner, the temporal state model 520 may be further configured to generate a number of time coordinates 523 from the time output 522, and the temporal query interface 560 may be further configured to resolve a request 562 to access the digital document 506 by employing the time coordinates 523. The time coordinates 523 may be generated during lifecycle transitions and authority events, may serve as structural state markers that define authoritative document boundaries, and may be normalized or generated from the time output 522. In one example, the time coordinates 523 may not be a version label or copy reference, but instead may be a temporal index into a single canonical document lineage.

For example, the canonical identity 507 and the time coordinates 523 may be input into the temporal query interface 560, and in response, the temporal query interface 560 may output an authoritative document state existing at a moment in time immediately after the transition from the malleable state to the fixed state. Note the transition from the first malleable representation 506-1A to the first fixed representation 506-1B at the top of FIG. 8, and in response, the first fixed representation 506-1B provided for by the temporal query interface 560. Accordingly, the temporal query interface 560 may return the authoritative document state that existed at the specified time without duplication, reconstruction, or branching. FIG. 8 thus illustrates that the system 502 contemplates non-duplication retrieval and canonical lineage enforcement.

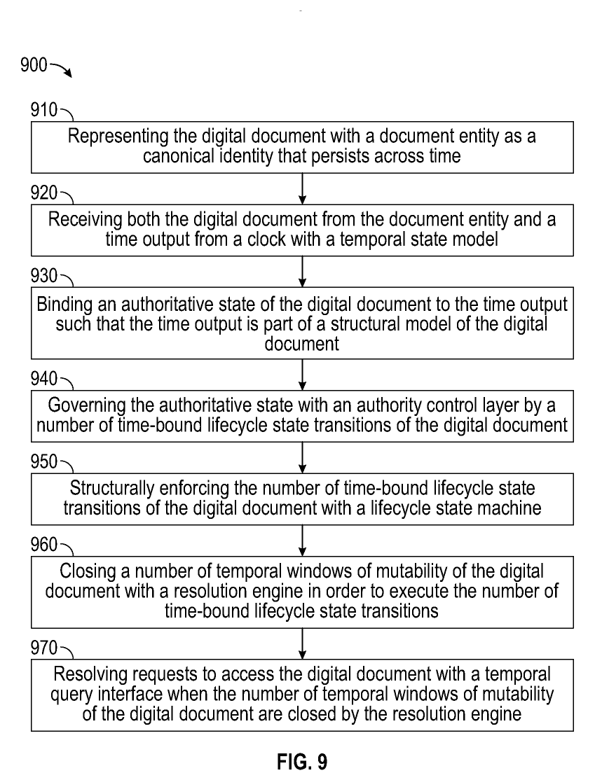

FIG. 9 shows a flow chart corresponding to an authority binding computer-implemented method 900 for a digital document. In one example, the method 900 comprises a first step 910 of representing the digital document 506 with a document entity 510 as a canonical identity 507 that persists across time; a second step 920 of receiving both the digital document 506 from the document entity 510 and a time output 522 from a clock 524 with a temporal state model 520; a third step 930 of binding an authoritative state of the digital document 506 to the time output 522 such that the time output 522 is part of a structural model 508 of the digital document 506; a fourth step 940 of governing the authoritative state with an authority control layer 530 by a number of time-bound lifecycle state transitions of the digital document 506; a fifth step 950 of structurally enforcing the number of time-bound lifecycle state transitions of the digital document 506 with a lifecycle state machine 540; a sixth step 960 of closing a number of temporal windows of mutability of the digital document 506 with a resolution engine 550 in order to execute the number of time-bound lifecycle state transitions; and a seventh step 970 of resolving requests to access the digital document 506 with a temporal query interface 560 when the number of temporal windows of mutability of the digital document 506 are closed by the resolution engine 550.

In one example, the third step 930 may be performed without auxiliary data being a governing dimension of the digital document 506. Moreover, the method 900 may further include a step of constantly providing the authoritative state to the digital document 506 after binding the authoritative state of the digital document 506 to the time output 522 with the temporal state model 520, as well as a step of providing the number of time-bound lifecycle state transitions of the digital document 506 as transitions between a malleable state corresponding to the digital document 506 being modifiable, a fixed state corresponding to the digital 6 being preserved at a specific moment in time, and an absolute state corresponding to the digital document 506 being permanently finalized. It will also be appreciated that the method 900 may further include a step of receiving an authority signal 532 at the authority control layer 530, and a step of triggering the number of time-bound lifecycle state transitions in the lifecycle state machine 540 in response to the authority control layer 530 receiving the authority signal 532, and independent of an editing action with respect to the digital document 506.

In this regard, the method 900 may further include a step of sending the authority signal 532 to the authority control layer 530 from an authorized cryptographic key 590 in order to cause the resolution engine 550 to close the number of temporal windows of mutability of the digital document 506. The method 900 may also further include a step of indexing the authoritative state with the temporal state model 520 by a number of time coordinates 523 without binding the authoritative state by at least one of, or all of, a number of version numbers of the digital document 506, a number of copies of the digital document 506, and a number of parallel authoritative document lineage branches derived from the canonical identity 507. Furthermore, it will be appreciated that the method 900 may also include steps corresponding to any of the functionality of the system 502, discussed above. It will also be appreciated that the user devices 570,710,712 disclosed herein may each include a corresponding processor and a corresponding memory having instructions that, when executed by the processor, cause the processor to perform the method 900.

Accordingly, the disclosed system 502 and method 900 may advantageously provide a temporal anchoring and sequencing mechanism that records when authoritative states occur, and may also ensure that downstream systems do not treat time-dependent events as interchangeable or retroactively mutable. The disclosed system 502 and method 900 may therefore not be a scheduler or logging system in the conventional sense, but instead may have as a function the binding of authority to time.

In one example, when a system other than the system 502 fixes agreed constraints into an authoritative, machine-enforceable form, the system 502 may record the moment of imprint. It will be appreciated that this timestamp may not merely be metadata, but instead the timestamp may become part of the authoritative context of the rule. In this regard, downstream systems may reference not just what rule was imprinted, but when such a rule became authoritative. In effect a rule may not be valid “in the abstract”, but may instead be valid from a specific point in time forward.

Additionally, other systems besides the system 502 may include or reference an entry of the digital document 506, which may indicate a time of imprint, a version boundary, and/or a sequence position relative to other rules or actions. As a result, later components may be prevented from treating older rules as if they were contemporaneous with newer ones.

Furthermore, it will also be appreciated that other systems besides the system 502 may freeze content of a rule, and the system 502 may freeze a temporal boundary of that rule. Together, such a system may prevent retroactive reinterpretation, backdating of authority, and/or substitution of “earlier” or “later” rules to justify actions. In this regard, a combined system in accordance with the disclosed concept may include other systems that answer the question “what cannot change,” in addition to the system 502 which may answer the question “when that ‘what’ became binding.”

Moreover, the system 502 may also be employed in combination with another system that presents actions for evaluation alongside a locked rule artifact. In this regard, the system 502 may provide a reference indicating when the rule became authoritative. This may ensure that an agent cannot cite a rule that did not yet exist, rely on a rule that was superseded, and/or collapse temporal ordering into a single abstract policy state. Such behavior may be inherently agentic, because the agent’s action proposal may be evaluated in a temporal context, not just a logical one.

Moreover, the system 502 may also be employed in combination with another system that performs binary enforcement (allow and block). In this regard, the system 502 may function to allow the gate to evaluate whether the proposed action is temporally valid and/or whether the rule being cited was authoritative at the time of action. Doing so may advantageously prevent “after-the-fact justification” or post hoc rule alignment.

Accordingly, it will be appreciated that the system 502 may not be a passive storage, but may instead actively participate in action evaluation by constraining which rules are eligible for enforcement, enforcing ordering between agreement, authority, and execution, and preventing agents from operating outside a coherent temporal frame. In other words, an agent may not be permitted to act unless a rule existed, unless a rule was imprinted before the action, unless a rule remained locked, and unless a rule was temporally applicable. As a result, the system 502 may be placed squarely in the agentic enforcement chain, not as infrastructure but as a control primitive.

It will also be appreciated that a core aspect of the system 502 may be intentional finality enforced by authority, meaning that an authorized party (or parties) may explicitly freeze or permanently seal a document state, at which point mutability may be structurally terminated by the system 502 rather than socially or procedurally. In other words, the system 502 may support controlled evolution until authority explicitly ends it, with finality enforced mechanically, not by convention.

Moreover, an important aspect of the system 502 may be that document mutability may be governed by explicit, authority-controlled state transitions, rather than continuous editability or static immutability. Specifically, the system 502 may enforce that the digital document 506 may be editable until an authorized party (e.g., the first author 701 in FIG. 7) executes a freeze event, which may be a formal state transition rather than a permission toggle. Authority to freeze, unfreeze, or permanently seal the digital document 506 may be delegated to another party, including multi-party or conditional authority. Freeze and seal events may also be part of the canonical lifecycle of the digital document 506 and may be preserved as authoritative temporal boundaries. Once the digital document 506 is permanently sealed by an authorized party (e.g., the first author 701), its state at that moment may become the definitive authoritative version, while all prior states may remain addressable and inspectable without duplication or branching. Accordingly, in one example at no point may multiple parallel authoritative versions exist. Instead, the system 502 may enforce a single canonical truth at any given time. Therefore, an important aspect of the disclosed concept may be that authority to end mutability and time-bound finality are enforceable primitives of the digital document 506 itself, rather than access control rules, version metadata, or social process.

In terms of how the system 502 functions, in one example, behavior of the digital document 506 may be governed by an explicit finite state machine, rather than by continuous editability or static immutability. Specifically, the system 502 may define and enforce distinct lifecycle states for a document, including but not limited to the malleable state, the fixed state, and the absolute state, each of which have been discussed above. More specifically, the malleable state may also correspond to the digital document 506 being modified, including by multiple participants, subject to authority rules; the fixed state may also correspond to the state of the digital document 506 at a specific time being preserved as an authoritative temporal boundary, with mutability suspended; and the absolute state may also correspond to the state of the digital document 506 being permanently finalized, and mutability being structurally terminated.

Transitions between these states may be formal state transitions (e.g., without limitation, not permission changes or user interface locks), and may be preserved as part of the canonical lifecycle of the digital document 506. In addition, the system 502 may treat document state as temporally addressable rather than versioned. The system 502 may resolve document access requests based on the canonical identity 507 and the time coordinates 523, returning the authoritative document state that existed at that moment, regardless of when the request 562 is made. Historical states may be accessed by temporal reference, not by retrieving stored copies or versions. Additionally, state transitions may be triggered by explicit authority events, rather than by ordinary editing actions.

In particular, freeze or seal transitions may be executed only upon receipt of a valid authority signal (e.g., the authority signal 532), which may be from the authorized cryptographic key 590 or another equivalent authority mechanism. As a result, this may cause the system 502 to close the prior temporal window and enforce immutability of the resulting state. These mechanics may ensure that finality be system-enforced, time-bound, and attributable, rather than socially or procedurally inferred. The system 502 may thus operate as a control system defined by explicit state transitions and temporal resolution, as opposed to a system that merely records changes, tracks versions, or relies on access control.

In one example, the system 502 may not be limited to single-author documents. The disclosed concept thus explicitly contemplates multiple participants interacting with the same digital document 506, while maintaining a single authoritative state at any given time. Critically, participation may be distinct from authority.

This is depicted in FIG. 7, wherein one or more authors 701,702 may be permitted to edit or interact with the digital document 506 concurrently, while the system 502 may enforce that mutability persists only until an authorized authority (e.g., the first author 701) executes a formal state transition (e.g., freeze, seal, or finalization event). Thus, the disclosed concept supports multiple actors interacting with the digital document 506 prior to finalization, supports authority to terminate mutability being explicitly governed and enforced by the system 502, and supports freeze and lock events acting as formal state transitions that end collaborative mutability. Additionally, after finalization, the disclosed concept contemplates that the authoritative state may be immutable, while all prior states may remain addressable and inspectable. The system 502 thus prevents ambiguity by ensuring that collaboration may not persist beyond authorized temporal boundaries. Accordingly, the system 502 may not be considered to be single-user–only, and may be distinguishable from collaborative editing systems that lack enforced finality or authority-based termination of mutability.

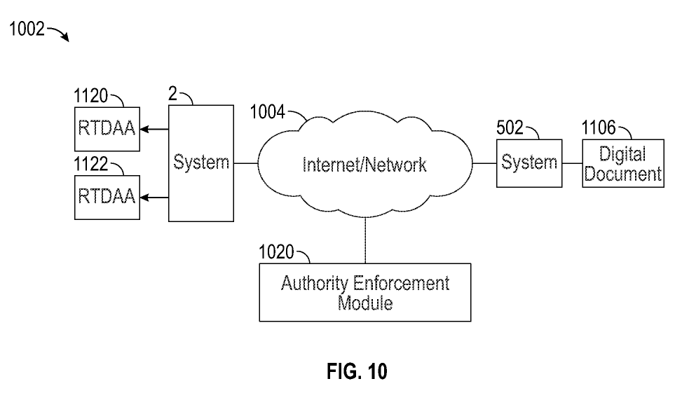

FIG. 10 is schematic view of an authorization system 1002, in accordance with one non-limiting embodiment of the disclosed concept. As shown, the system 1002 includes the system 2 (FIG. 1), the system 502 (FIG. 4), and an authority enforcement module 1020, each of which may be communicable over an internet / network 1004. In one example, the cryptographic module 10 of the system 2 may be configured to generate a first real-time digital authorization artifact 1120 based on a first live human authorization event, emit the first real-time digital authorization artifact 1120, generate a second real-time digital authorization artifact 1122 based on a second live human authorization event, and emit the second real-time digital authorization artifact 1122. Generation and emission of the artifacts 1120,1122 may be performed as described above in connection with FIGS. 1-3.

Continuing to refer to FIG. 10, the document entity 510 of the system 502 may be configured to consume the first real-time digital authorization artifact 1120 as an authority access signal in order to trigger a number of lifecycle state transitions of a digital document 1106 being represented by the document entity 510, and the temporal query interface 56 may be configured to employ the second real-time digital authorization artifact 1122 in order to resolve requests to access the digital document 1106. Additionally, in accordance with the disclosed concept, the authority enforcement module 1020 may be configured to receive a sequence from an autonomous agent, and prevent the autonomous agent from accessing the digital document 1106 because the autonomous agent did not generate the first and second real-time digital authorization artifacts 1120,1122.

In one example, it will be appreciated that the authority enforcement module 1020 may operate without requiring modification of the cryptographic module 10, the document entity 510, and the temporal query interface 560. Furthermore, the authority enforcement module 1020 may advantageously act as a coordination layer between the system 2 and the system 502, thereby ensuring that every authorization artifact of the system 2 is automatically piped into the system 502 as a triggered entry event without requiring additional user action. As will be discussed below, the authority enforcement module 1020 may govern a toggle map by presenting a user or administrator with a configurable gate assignment interface across applications, folders, drives, and critical actions. Each toggle-on location may activate an independent gate of the system 2 and trigger automatic recording of the system 502 at that location. The authority enforcement module 1020 may also enforce a deployment model, optionally a plug-in deployment model, by sitting on top of existing host infrastructure without requiring modification of the cryptographic module 10, the document entity 510, or the temporal query interface 560. It will also be appreciated that the authority enforcement module 1020 may be independently deployable, meaning it can operate as a standalone document governance layer, as a toggle map only, or as both together.

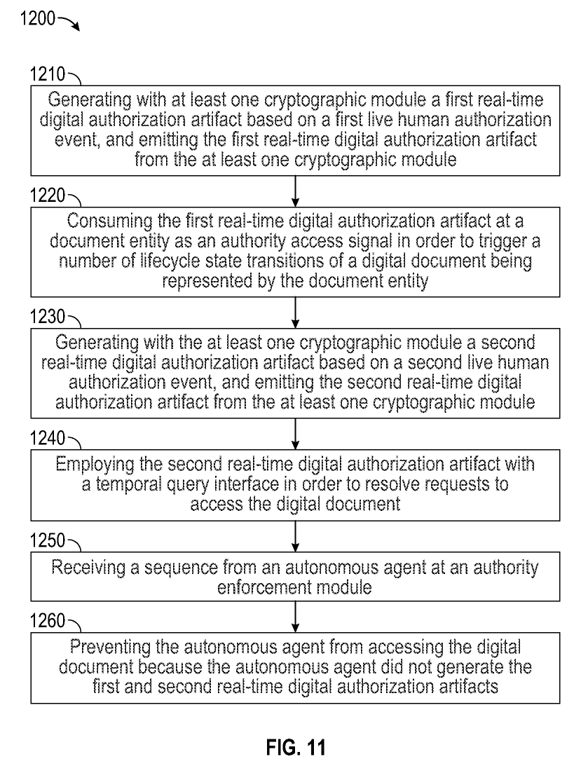

FIG. 11 shows an example computer-implemented authorization method 1200 which may be performed by the authorization system 1002 of FIG. 10. In one example, the method 1200 comprises a first step 1210 of generating with at least one cryptographic module 10 a first real-time digital authorization artifact 1120 based on a first live human authorization event, and emitting the first real-time digital authorization artifact 1120 from the at least one cryptographic module 10; a second step 1220 of consuming the first real-time digital authorization artifact 1120 at a document entity 510 as an authority access signal in order to trigger a number of lifecycle state transitions of a digital document 1106 being represented by the document entity 510; a third step 1230 of generating with the at least one cryptographic module 10 a second real-time digital authorization artifact 1122 based on a second live human authorization event, and emitting the second real-time digital authorization artifact 1122 from the at least one cryptographic module 10; a fourth step 1240 of employing the second real-time digital authorization artifact 1122 with a temporal query interface 560 in order to resolve requests to access the digital document 1106; a fifth step 1250 of receiving a sequence from an autonomous agent at an authority enforcement module (e.g., without limitation, authority enforcement module 1020); and a sixth step 1260 of preventing the autonomous agent from accessing the digital document 1106 because the autonomous agent did not generate the first and second real-time digital authorization artifacts 1120,1122. In one example, the sixth step 1260 may be performed without relying on at least one of or each of an organizational policy, a permission, a workflow label, and a social convention.

It will be appreciated that the method 1200 may include steps associated with the methods 400,900, discussed above. For example, the method 1200 may include a step of receiving the digital document 1106 from the document entity 510 after consuming the first real-time digital authorization artifact 1120, receiving a time output from a clock (e.g., see time output 522 of clock 524 in FIG. 5), and binding an authoritative state of the digital document 1106 to the time output 522 such that the time output 522 is part of a structural model of the digital document 1106. The method 1200 may also include steps of governing the authoritative state by a number of time-bound lifecycle state transitions of the digital document 1106 with an authority control layer 530; structurally enforcing the number of time-bound lifecycle state transitions of the digital document 1106 with a lifecycle state machine 540; and closing with a resolution engine 550 a number of temporal windows of mutability of the digital document 1106 in order to execute the number of time-bound lifecycle state transitions. Moreover, it will also be appreciated that the method 1200 may include providing the document entity 510 as being architecturally separated from the cryptographic module 10. Additionally, the method 1200 may also include a step of receiving an authorization challenge at a user device 50 before generating with the at least one cryptographic module 10 the first real-time digital authorization artifact 1120, and the authorization challenge may be non-replayable and dynamically generated in real-time.

Accordingly, the system 1002 may be a control layer, optionally a plug-in control layer, for critical documents that sits on top of existing systems (e.g., without limitation, the systems 2,502) without requiring infrastructure replacement. The system 1002 may govern how documents are accessed, modified, and finalized by coordinating the systems 2,502, which may work together as a unified enforcement layer. In order to perform this function, the system 1002 may work through two sequential gates provided by the system 2. The first gate of the system 2 may control access to the system 1002 itself, wherein no session may open without a live human authorization event. This means that an artificial intelligence (AI) agent with valid credentials may not initiate a session at all. The second gate may control access to the documents specifically. In one example, even if access is granted to the system 1002, reaching critical documents may require a second independent live human authorization event. Furthermore, the system 502 may then govern the digital document 1106 once accessed, enforcing three lifecycle states—malleable, fixed, and absolute—and ensuring that once the digital document 1106 is finalized, its state is permanently closed and structurally unalterable.

It will also be appreciated that the digital document 1106 (and any other digital document) may be placed into the system 1002 at any stage—not just at finalization—giving organizations the ability to govern critical documents from the moment they are created, not just at the end of their lifecycle. Accordingly, the method 1200 may further include steps of governing the digital document 1106 at a moment of creation of the digital document 1106, as well as preventing a temporal sequence from being at least one of or each of rewritten, backdated, and reordered. In this manner, the method 1200 may further include locking the first real-time digital authorization artifact 1120 into a specific temporal sequence via treating a time output 522 of a clock 524 as a structural primitive rather than metadata. Additionally, locking in such a step may be performed in order to capture a biometric verification, a device binding reference, a specific action requested, and a time coordinate as a structural element, each associated with the first live human authorization event. The combined effect of the functionality of the system 1002 may be a closed-loop system. In this manner, an agent may not open a session, may not reach the documents, and even if it somehow did, may not alter anything that has been structurally finalized. The system 1002 may make this guarantee without relying on organizational policy, permissions, workflow labels, or social convention, and the guarantee may be enforced at the architectural level.

Accordingly, the first real-time digital authorization artifact 1120 may serve as an authority signal that triggers lifecycle state transitions in the system 502. The two systems 2,502 may thus operate as a closed loop wherein the system 2 may govern who can act and the system 502 may govern what becomes permanently authoritative as a result of that action. Together, the systems 2,502 may create a dual guarantee such that an agent may not act without live human authorization, and may also not retroactively alter what has been structurally finalized. Furthermore, the system 1002 may be particularly advantageous in a scenario where an AI agent attempts a chained or recursive action sequence. In such a scenario, the system 2 may block each invocation without a fresh live human artifact, the system 502 may simultaneously prevent the agent from altering any document that has already entered a fixed or absolute state, and the combined effect may be that the agent cannot act forward and cannot alter the past. The system 1002 may provide these benefits by having the authority enforcement module 1020 sit on top of the systems 2,502 without requiring infrastructure replacement. Specifically, the authority enforcement module 1020 may be configured to automatically pipe every authorization artifact (e.g., the first and second real-time digital authorization artifacts 1120,1122) into the system 502 as a triggered entry event, wherein the two systems 2,502 may stop being separate gears and may become a single continuous audit engine.

Put differently, a live human authorization event may be verified and the first real-time digital authorization artifact 1120 may be generated. Rather than the first real-time digital authorization artifact 1120 simply being consumed by a requester system (e.g., the requester system 30, FIG. 2B) as a prerequisite for an action, the first real-time digital authorization artifact 1120 may be simultaneously sent to the system 502 as an authority signal. The system 502 may then create an immutable entry event. Because the system 502 may treat time as a structural primitive rather than metadata, the system 502 may lock that authorization into a specific temporal sequence that cannot be rewritten, backdated, or reordered. Accordingly, the immutable entry event may capture the who (biometric verification), the where (device binding reference), the what (the specific action requested), and the when (time coordinate as a structural element, not a label). The result may be a deterministic, cryptographically sealed, temporally ordered record of every human authorization event—permanent, immutable, and structurally enforced. As such, the method 1200 may further include providing a cryptographically sealed, temporally ordered, and structurally immutable record of the first live human authorization event. In this manner, the system 1002 may be configurable for a Black Box for the Agentic Web. For example, in aviation, the black box records everything so investigators can reconstruct exactly what happened. The system 1002 may thus be configured to solve issues in aviation and other industries.

It will also be appreciated that the system 1002 may do the same for AI-authorized actions. For example, an agent may not claim a human authorized something off the record. If it is not in the system 502, it did not happen. Moreover, non-repudiation may become structural: a party may not later deny authorizing an action because the system 502 contains the cryptographically sealed real-time digital authorization artifacts 1120,1122 at exact temporal coordinates. Furthermore, if an agent begins acting outside its authorized scope, the system 502 may provide a complete forensic timeline showing exactly which human authorization event opened the window and when.

Continuing to refer to FIGS. 10 and 11, when the authority enforcement module 1020 is configured in the manner described herein, the first and second real-time digital authorization artifacts 1120,1122 may automatically and simultaneously be piped into the system 502 as a triggered entry event. This may happen without any additional user action. The authorization event and the permanent record of that authorization may become the same event. Accordingly, the system 502 may capture for each live human authorization event a who (e.g., the biometric verification confirming the correct authorized human was present), a where (the device binding reference confirming the enrolled device was used), a what (the specific action that was requested and authorized), and a when (a time coordinate treated as a structural primitive, not a timestamp label, meaning it cannot be backdated, reordered, or rewritten). The result may be a continuous, automatic, immutable ledger of every human authorization event in the system. Because the system 502 may treat time as a structural element rather than metadata, the sequence of entries may be deterministic and permanent. No entry may be inserted before an existing entry. No entry may be altered after the fact. No entry may be deleted. As such, if an action occurred, there may be an entry of the system 2 in the system 502 proving that a real human authorized it, on a specific device, at a specific moment. Moreover, if there is no entry, the action may not have authorized human origin. Furthermore, if an agent attempts to act without authorization, there may be no entry and therefore no legitimacy. Additionally, if a party later attempts to deny authorizing an action, the entry in the system 502 may provide cryptographically sealed, temporally ordered, structurally immutable proof. Accordingly, the system 1002 may not be a logging system in the conventional sense and may not be an audit trail layered on top of the system 502. Instead, the system 1002 may be the authorization event itself becoming a permanent structural record—because the real-time digital authorization artifacts 1120,1122 may be the authority signal that the system 502 acts on. That is, the record and the authorization may be the same thing.

In one example, the authority enforcement module 1020 may sit on top of the systems 2,502 without requiring modification or replacement of the host infrastructure. Specifically, the architecture may cover two distinct deployment contexts. First, the authority enforcement module 1020 may be deployed as a control layer, optionally a plug-in control layer, on top of existing enterprise systems—document management platforms, financial systems, legal infrastructure, healthcare records, or any environment where critical documents and authorized actions must be governed and permanently recorded. This means that these existing infrastructures do not need to be ripped out. Instead, the authority enforcement module 1020 may be a control layer on top. Second, the authority enforcement module 1020 may optionally be deployed as a plug-in module for individual users on personal devices—protecting personal documents, financial records, and any information where the individual needs provable human authorization and permanent records of access and finalization. In both cases the core guarantee may be identical: no access without live human presence, such that every document may be governed from entry regardless of lifecycle stage, every authorization event permanently sealed in the system 502. In this manner, the optional plug-in nature may mean that the system 1002 is deployment-agnostic, that it governs whatever host system it sits on top of, whether that be at enterprise or personal scale, without modifying the core logic of that host system.

Continuing to refer to FIGS. 10 and 11, in one example a user or administrator may be presented with a map of their system—applications, folders, drives, and critical actions. Each location may have a toggle. When toggled on, a gate provided by the system 2 may be activated at that specific location, requiring live human authorization to access it. When toggled off, normal access applies. This means that the system 2 may not be fixed at a single system entry point—it may be configurable and deployable by the user across any number of specific locations within their computing environment. Every toggle-on location may automatically pipe the first and second real-time digital authorization artifacts 1120,1122 into the system 502, creating a permanent sealed record of every human authorization event at that location. The system 1002 may thus provide for a user or administrator configurable gate assignment via toggle interface, the system 2 being deployable at application, folder, drive, or action level independently, automatic recording by the system 502 triggered at each toggled location, and independent deployment—each toggle may operate as a separate gate. Furthermore, the above-described functionality may work across windows enterprise and personal computing environments. Accordingly, the method 1200 may further include providing a plurality of different locations within a computing environment each being at least one of a computer application, a computer folder, a computer drive, and a computer critical action. In this manner, the first step 1210 may be performed responsive to the cryptographic module 10 being toggled on by a user at one of the plurality of different locations.

Additionally, within the system 1002, the authority enforcement module 1020 may operate as its own dedicated section governing critical documents. Documents may enter the authority enforcement module 1020 at any lifecycle stage—malleable, fixed, or absolute—and may be governed from the moment of entry. The authority enforcement module 1020 may be independently deployable within a computing environment, meaning a user can use a toggle map alone, the authority enforcement module 1020, or both together. Accordingly, the method 1200 may further include providing the authority enforcement module 1020 as an independently deployable module within a computing environment. Documents may thus be governed from point of entry regardless of lifecycle stage.

Continuing to refer to FIGS. 10 and 11, the system 1002 may operate in a chained or recursive AI scenario, where each AI invocation in a chain may require a separate fresh live human authorization artifact. This means that the system 1002 may block not just the first unauthorized agent action but every subsequent chained action in the sequence. Furthermore, the system 1002 may be configured such that the authority enforcement module 1020 may govern documents from the moment of their creation, not just at access or finalization. The system 1002 may thus provide for a property corresponding to entry at any lifecycle stage being governed. In terms of the non-repudiation property of the system 1002, because the authorization event and the record of the system 502 may be the same atomic event, no party may later deny having authorized an action. The sealed record may thus constitute structural proof at exact temporal coordinates. Additionally, the system 1002 may be agnostic to a specific biometric modality used by the cryptographic module 10. The optional plug-in architecture may function identically regardless of whether the challenge-response of the system 2 uses voice, face, or touch.

In a native integration of the disclosed concept, architectures of the systems 2,502 may be built directly into an application or platform rather than deployed as an external plug-in. For example, a company like Microsoft may implement the system 1002 inside their agent platform. Additionally, a gate of the system 2 and a seal by the system 502 may be exposed as cloud-based APIs that any application calls directly, similar to how payment processors work. This iteration may not be a plug-in, but may be a service. Furthermore, the cryptographic module 10 may also be implemented at a chip or device firmware level rather than in software. Moreover, the system 1002 may also sit inside an existing identity layer such as Okta or Azure AD rather than as a standalone module. Accordingly, as used herein, an “authority enforcement module” is configured to provide the disclosed functionality in each of these iterations, including both in a plug-in iteration and a non-plug-in iteration.

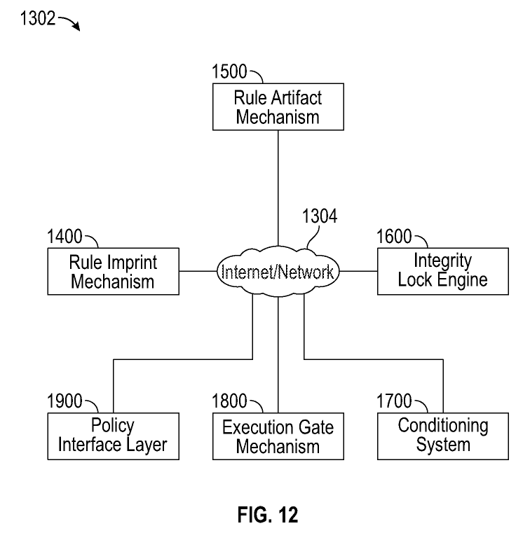

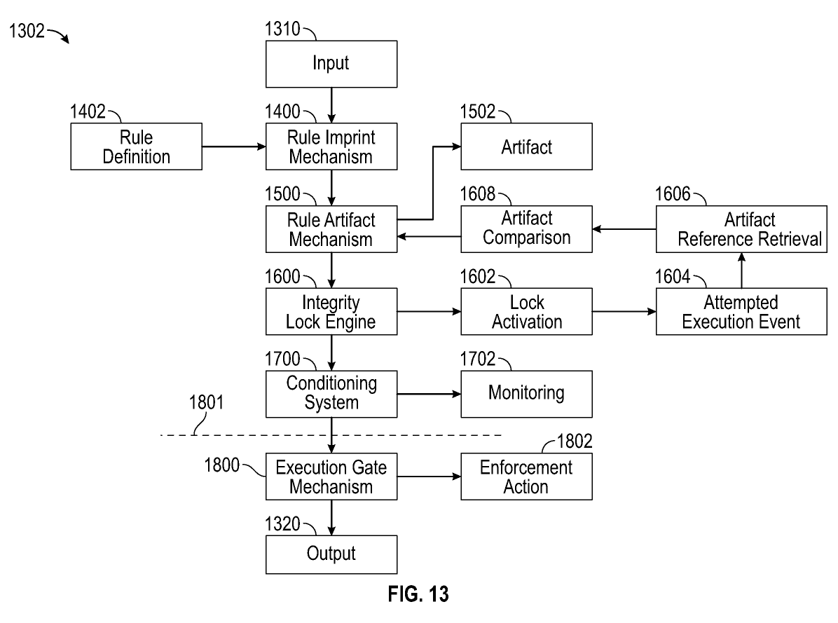

FIGS. 12 and 13 show a deterministic control system 1302, in accordance with one non-limiting embodiment of the disclosed concept. In one example, the system 1302 may be an agentic system that performs actions, but may be architected such that it must request and be granted permission before acting. That is, the system 1302 may not be configured to self-authorize execution. In one example, the system 1302 may be capable of planning and taking actions, including a mandatory permission-before-action requirement, providing that execution may be contingent on an external authorization signal, and not allowing for autonomous execution without approval. The system 1302 may also be designed for environments where humans or external systems may be unable to intervene in real time.

It will also be appreciated that the system 1302 may be intended as a safety-forward architecture for future agentic systems, may be model-agnostic and architecture-agnostic, may not be a post-hoc monitoring or rollback system, may not be merely a policy layer or prompt constraint, and may be distinct from human-in-the-loop user interface (UI) approvals (e.g., without limitation, may be system-to-system). Conceptually, the system 1302 may not be an “execution gate” in isolation, and may not be just another agent. Instead, the system 1302 may provide that the agent itself may be structurally incapable of acting without permission being granted, even if it has the capability to do so.

In one example, as shown in FIG. 12, the system 1302 may separate law creation, immutability, communication, and enforcement via a number of distinct mechanisms. Specifically, the system 1302 may include a rule imprint mechanism 1400, a rule artifact mechanism 1500, an integrity lock engine 1600, a conditioning system 1700, and an execution gate mechanism 1800. In addition to the subsystems 1400,1500,1600,1700,1800, the system 1302 may also include a policy interface layer 1900, which may function to allow rule configuration, versioning, and updates between the subsystems 1400,1500,1600,1700,1800, while preserving artifact history and preventing silent mutation of active rules.

Regarding rule updates, it will be appreciated rule mutation within the system 1302 may not be configured to occur silently. That is, updates may require artifact regeneration via the rule artifact mechanism 1500, prior artifact states to be preserved, and lock reset events to be logged or require explicit authorization.

Continuing to refer to FIG. 12, the rule imprint mechanism 1400 may fix agreed constraints as authoritative rules prior to execution, the rule artifact mechanism 1500 may provide a persistent, inspectable representation produced by the rule imprint mechanism 1400. Moreover, the integrity lock engine 1600 may freeze imprinted rules to prevent modification or reinterpretation, the conditioning system 1700 may provide a mandatory communication and mediation plane through which actions may be expressed and evaluated, and the execution gate mechanism 1800 may provide for binary runtime enforcement (e.g., without limitation, allow and block). Each of these mechanisms will now be discussed in detail.

First, the rule imprint mechanism 1400 may address semantic drift problems in the art by providing a process by which agreed constraints may be translated into executable form at a defined pre-execution moment, with the system 1302 structurally preserving original meaning and fixing the rule as authoritative before any execution is possible. As a result, the rule imprint mechanism 1400 of the system 1302 may provide explicit separation between agreement and execution, translation of human-level constraints into machine-enforceable rules with semantic fidelity, fixation of rules prior to any action attempt, generation of an authoritative rule representation referenced downstream, and prevention of silent reinterpretation during configuration or deployment. An important benefit of the rule imprint mechanism 1400 may not be rule storage or policy definition, but instead may be a structural guarantee that enforcement later be based on the same meaning that existed at agreement time, eliminating pre-execution drift. Accordingly, a function of the rule imprint mechanism 1400 may be to capture a defined rule set (e.g., without limitation, constraints, verification requirements, system policies) and encode them into structured system configuration data. The rule imprint mechanism 1400 may thus be a rule definition and normalization layer for the system 1302.

Second, the rule artifact mechanism 1500 may provide the system 1302 with a persistent, inspectable representation produced by the rule imprint mechanism 1400. In this regard, the rule artifact mechanism may embody the imprinted rule and serve as the authoritative reference for enforcement. Characteristics of the rule artifact mechanism 1500 may be generation as an output of the rule imprint mechanism 1400, binding to original agreement context, reference but not modification by downstream components, and inspection for audit, traceability, or compliance. Accordingly, a function of the rule artifact mechanism 1500 may be to generate a persistent, structured representation (e.g., without limitation, an artifact 1502) of the rule set (e.g., without limitation, structured object, checksum, hash, immutable record), wherein this artifact 1502 may become the authoritative reference for enforcement and audit.

Third, the integrity lock engine 1600 may freeze imprinted rules once set, preventing modification, substitution, or silent reinterpretation throughout execution. Important functional characteristics include the integrity lock engine 1600 functioning after the rule imprint mechanism 1400, preventing rule mutation or bypass, ensuring downstream enforcement references the same fixed rule, and enforcing immutability by structure, not policy or trust. Accordingly, the integrity lock engine 1600 may ensure that once a rule set is defined and artifacted, downstream execution may not silently deviate. Therefore, an example function of the integrity lock engine 1600 may be to monitor attempted actions of the system 1302, and compare them against the artifact 1502 generated by the rule artifact mechanism 1500, wherein if a deviation is detected, the integrity lock engine 1600 may block execution, flag the deviation, log the event, and/or escalate for review. The integrity lock engine 1600 thus enforces rule fidelity, and may not generate rules. It will also be appreciated that the integrity lock engine 1600 may bind execution authority to a specific artifact state or version. In particular, once the integrity lock engine 1600 is activated, actions of the system 1302 may be required to reference a specific artifact instance (or version identifier). Moreover, it will be appreciated that reinterpretation, parameter mutation, and/or configuration drift may trigger detection and/or invalidation in the integrity lock engine 1600.

Fourth, the conditioning system 1700 may be a mandatory communication and mediation plane through which all execution-relevant actions must pass. Important functional characteristics of the conditioning system 1700 may include required presentation of the locked rule artifact alongside any proposed action, presented constraints to the acting model before execution, routing action and rule context for enforcement evaluation, communicating enforcement outcome back to the model, and not defining rules or exercising discretion. Accordingly, the conditioning system 1700 may ensure that no action can be proposed or executed outside the rule context.

Finally, the execution gate mechanism 1800 may perform a mechanical, binary enforcement step for the system 1302. Important characteristics of the execution gate mechanism 1800 include evaluation of a proposed action against the locked rule artifact 1502, making a pass/fail determination (e.g., without limitation, allow or block), providing for a sole enforcement decision point, and not providing for discretion or interpretation. Accordingly, it will be appreciated that the execution gate mechanism 1800 may determine whether an action may proceed before execution occurs, and in which execution may be contingent on external approval, and operation is across heterogeneous agentic systems.

In one example, the execution gate mechanism 1800 may be configured for pre-execution authorization, constraint, and control of agentic/autonomous actions, especially where human oversight may be unavailable, delayed, or impractical. More particularly, the execution gate mechanism 1800 may be a system that sits between an agent’s intent and real-world execution, requiring a pre-execution authorization decision (e.g., allow / deny / sandbox / require escalation) based on structured action semantics, risk classification, and policy constraints, before any external side effects occur. In this regard, the execution gate mechanism 1800 may be configured to intercept an execution request before a tool/function/API/actuator call is performed, and decide whether execution is permitted, under what constraints, and with what required confirmations. The execution gate mechanism 1800 may thus not be a model improvement, but instead be outside the model, sitting at the boundary between an agent’s decision/plan/output, and external execution surfaces (tools/APIs/OS/DB/network/commerce/robotics). It will be appreciated that the execution gate mechanism 1800 may be a true execution boundary gate that blocks or constrains an action before any side effect occurs, as opposed to systems that evaluate outputs after execution, monitor for errors after the fact, provide warnings, rely on human approval in ordinary UX (generic “confirm?”), are purely transport-level acknowledgments, and are merely planning checks or “self-critique” before acting (without hard enforcement).

In accordance with the disclosed concept, an “agent” or “autonomous system” as used in connection with the execution gate mechanism 1800 may be a system that selects and triggers actions through tools/APIs based on goals, “execution” as used in connection with the execution gate mechanism 1800 may be any operation that produces external side effects (API call, file write, DB update, payment, message send, provisioning, deployment, etc.), and “execution gate” as used in connection with the execution gate mechanism 1800 may be a control surface/system that can deny/allow/sandbox/constraint execution at run time.

In this regard, an “agent” in the execution gate mechanism 1800 may produce an action intent (e.g., “send email,” “issue refund,” “deploy update,” “wire payment,” “delete record,” “book travel,” “download dataset,” etc.), an action may be intercepted at the execution boundary (before tool/API invocation), and a gate may extract/construct a structured action representation (“Action Packet”). In one example, such a structured action representation may include an action type (send, delete, purchase, deploy, transfer, edit, message, etc.), a target(s) (account, recipient, endpoint, record set, environment), parameters (amount, payload size, access scope, permissions), dependencies (required credentials, required approvals), and expected side effects (creates charge, changes state, writes files, etc.).

Furthermore, the gate of the execution gate mechanism 1800 may run a pre-execution evaluation, which may include policy rules (allowlist/denylist), scope constraints (limit recipient domains, max $ amount, read-only mode), risk scoring / classification (reversible vs irreversible), and environment constraints (sandbox vs production). In turn, the gate may produce an authorization decision (e.g., ALLOW (execute as requested), ALLOW WITH CONSTRAINTS (modify execution parameters: rate limit, reduce scope, redact, restrict target, force sandbox), REQUIRE ESCALATION (trigger multi-party authorization, second-agent attestation, or delayed execution window), and DENY (block execution)). Subsequently, it is contemplated that only after an “allow” state may execution proceed. Otherwise the action may be blocked, sandboxed, or escalated without side effects.

Example real-world use cases of the execution gate mechanism 1800 include finance, DevOps, Security, Messaging, and Robotics/IoT. In the Finance space, an agent may try to initiate a $25,000 transfer, and the gate of the execution gate mechanism 1800 may require escalation plus secondary authorization, and may block the transfer if it is outside a policy. In the DevOps space, an agent may try to deploy to production, and the gate of the execution gate mechanism may force staging-only unless release window and approvals are met. In the Security space, an agent may attempt to exfiltrate a customer dataset, and the gate of the execution gate mechanism 1800 may deny the action due to data classification and scope rules. In the Messaging space, an agent may try to email an external domain, and the gate of the execution gate mechanism 1800 may require listed domains or strips attachments. In the Robotics/IoT space, an agent may try to actuate a physical command, and the gate of the execution gate mechanism 1800 may check safety constraints and environment state first.

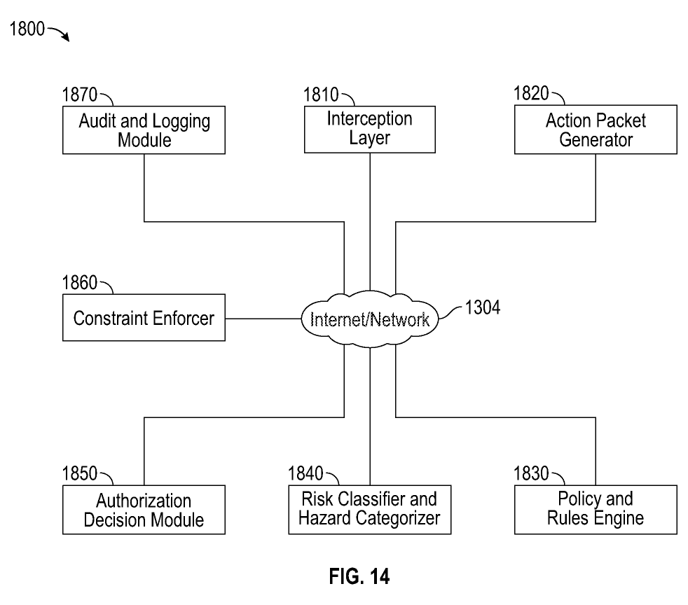

FIG. 14 shows a detailed view of the execution gate mechanism 1800. In one example, the execution gate mechanism 1800 may include an interception layer 1810, an action packet generator 1820, a policy and rules engine 1830, a risk classifier and hazard categorizer 1840, an authorization decision module 1850, a constraint enforcer 1860, and an optional audit and logging module 1870, each of which may communicate over the internet/network 1304. The interception layer 1810 may intercept tool/API calls, and prevent direct execution without gate decision. The action packet generator 1820 may convert raw action instruction into structured representation: type, target, parameters, side effects, context. The policy and rules engine 1830 may evaluate constraints, allowlists, prohibited actions, budgets, time windows, and user/org policies. The risk classifier and hazard categorizer 1840 may assign action risk class (irreversible/destructive/financial/privacy/security/reputation). The authorization and decision module 1850 may return allow/deny/sandbox/escalate/allow-with-constraints. The constraint enforcer 1860 may apply constraints (e.g., without limitation, sandbox, throttle, scope reduction, redactions, target restrictions). The audit and logging module 1870 may store action packets, decisions, rationales, and metadata for traceability.

In an alternative embodiment, the execution gate mechanism 1800 may also provide for multi-agent attestation mode such that a gate may require a second agent (or independent module) to confirm an interpretation and risk class of the action packet generator 1820 before allowing execution. In terms of policy modularity, the execution gate mechanism 1800 may also provide for per-action-type plug-ins (payments, data access, deployment) with distinct rule sets, dynamic thresholds in which a user/org can set tolerance (“strict mode,” “standard,” “relaxed”) that change what requires escalation, as well as a fail-safe mode in which if a gate cannot evaluate, the execution gate mechanism 1800 may default to deny or sandbox. Furthermore, the execution gate mechanism 1800 may also provide for explicit “NOT this” exclusions (to keep the search clean).

Moreover, the execution gate mechanism 1800 may be different than known systems (not shown), which are typically policy-driven authorization (PaC / PDP-PEP / deontic reasoning / constitutions), in which actions are evaluated against externally defined rules, permissions, or obligations, and enforcement outcomes flow from compliance with those rule sets. By way of contrast, in one example a core gating decision of the execution gate mechanism 1800 may not be policy compliance, but instead may be a structural action irreversibility classifier that operates prior to policy logic. This may present as a first-pass, non-policy evaluation that classifies an action as reversible vs. irreversible (or side-effect-free vs. side-effect-bearing). For example, irreversible actions may be categorically prevented in the execution gate mechanism 1800 from executing autonomously unless routed through a different execution mode (sandbox, delayed window, escrowed execution), regardless of policy allowlists, and policy rules, if present, may be secondary rather than primary decision drivers.

Referring to FIG. 13, the rule imprint mechanism 1400 may be configured to receive an input 1310 and the execution gate mechanism 1800 may be configured to produce an output 1320. In terms of interoperability, in one example, the rule imprint mechanism 1400 may define constraints, the rule artifact mechanism 1500 may memorialize constraints in structured form, the integrity lock engine 1600 may enforce fidelity to the artifact, the conditioning system 1700 may govern cross-system communication boundaries, and the execution gate mechanism 1800 may authorize or block downstream execution based on clearance of the integrity lock engine 1600. Furthermore, the integrity lock engine 1600 may prevent silent rule drift, the execution gate mechanism 1800 may prevent physical or digital execution absent lock compliance, and the conditioning system 1700 may ensure inter-system interactions honor the same rule framework. The subsystems 1400,1500,1600,1700,1800 are thus modular, but logically dependent. It will also be appreciated that the rule imprint mechanism 1400 may receive a rule definition 1402, the rule artifact mechanism 1500 may generate an artifact 1502, the integrity lock engine 1600 may provide for a lock activation 1602, the conditioning system 1700 may perform monitoring 1702, and the execution gate mechanism 1800 may perform an enforcement action 1802.

FIG. 13 also demonstrates an enforcement boundary within the system 1302. As shown, after the integrity lock engine 1600 provides for the lock activation 1602, a sequence within the system 1302 before the enforcement action 1802 may include receipt of an attempted execution event 1604 (e.g., a downstream system action may be requested (e.g., an API call, a transaction, a deployment, an AI output release, etc.)), and an artifact reference retrieval 1606 in which the system 1302 retrieves the active rule artifact 1502 associated with the locked state. Subsequently, such a sequence may further include an artifact comparison 1608 in which the attempted execution parameters (e.g., via the attempted execution event 1604) may be compared against artifact-defined constraints of the system 1302. In this regard, a compliance determination may be generated by the system 1302 in the form of either a match or a deviation. If compliant, the execution gate mechanism 1800 may authorize execution. If not compliant, the execution gate mechanism 1800 may block, flag, or log an action. Accordingly, a decision of the execution gate mechanism 1800 may be downstream of the artifact comparison 1608, which may produce a binary compliance output. In this regard, the system 1302 may be considered to have a deterministic authorization boundary 1801 between the artifact comparison 1608 and the execution gate mechanism 1800. The system 1302 may thus provide for artifact state binding, deterministic comparison, and binary authorization outcome.

Regarding artifact version binding, it will be appreciated that within the system 1302, each rule artifact may be assigned a unique artifact identifier and a version identifier, and execution requests may reference the currently active artifact identifier. In certain embodiments, an execution request that does not reference the currently active artifact identifier may automatically be rejected. Moreover, in response to the lock activation 1602 by the integrity lock engine 1600, modification of rule parameters associated with the artifact 1502 may be disabled at the system level until a regeneration event occurs. Moreover, a regeneration event in accordance with the disclosed concept may include creation of a new artifact instance and reassignment of the active artifact identifier. Additionally, the integrity lock engine 1600 may perform a parameter-level comparison between execution request attributes and constraints defined in the active artifact. In one example, the execution gate mechanism 1800 may operate solely on the binary compliance output and perform no independent reinterpretation. Thus, the deterministic control system 1302 may not permit discretionary override of a non-compliant determination without artifact regeneration.

Continuing to refer to FIG. 14, in one example consumption of the rule artifact 1502 (FIG. 13) may be atomic, such that only one execution may win. Duplicate or near-simultaneous submissions using the same artifact must fail in one embodiment. The rule artifact 1502 may also be bound not just to the authorized parties but to the specific action payload or action hash. If the action parameters change after the rule artifact 1502 is issued, the rule artifact 1502 may become invalid. A modified request may not reuse a prior artifact. Additionally, degraded system states — including timeout, latency spike, ledger service lag, or policy service unavailability — may result in deny or sandbox behavior, and in one example never implicit allow. The system 1302 may fail closed for consequential actions. Moreover, agent self-reported assertions alone may not trigger artifact issuance, critical issuance criteria may be validated from trusted external sources, and context tampering or manipulated inputs may cause fail-closed behavior rather than artifact issuance.

Accordingly, in one example a computer-implemented deterministic control method may comprise issuing a rule artifact 1502 with a rule artifact mechanism 1500 of a deterministic control system 1302, the rule artifact 1502 being bound to a predetermined action payload and a predetermined context; atomically consuming the rule artifact 1502 at an integrity lock engine 1600 of the deterministic control system 1302 such that only one execution of the integrity lock engine 1600 can occur; and invalidating the rule artifact 1502 responsive to a change in action parameters of the deterministic control system 1302, thereby defaulting the deterministic control system 1302 to both deny a number of pre-execution authorization decisions and require an external validation of a number of issuance criteria. The aforementioned method may further comprise preventing the rule artifact 1502 from being reused in response to the change in action parameters. The aforementioned method may also comprise determining that a state of the deterministic control system 1302 has degraded, and preventing the deterministic control system 1302 from operating in an implicit allow mode in response to determining that the state of the deterministic control system 1302 has degraded. In this regard, determining that the state of the deterministic control system 1302 has degraded may comprise detecting in the deterministic control system 1302 at least one of a timeout, a latency spike, a ledger service lag, and a policy service unavailability. Moreover, the invalidating step in the aforementioned method may further include detecting that an autonomous agent has crossed between a low-security context and a higher security context, and may be performed without accepting a self-assertion of at least one autonomous agent.

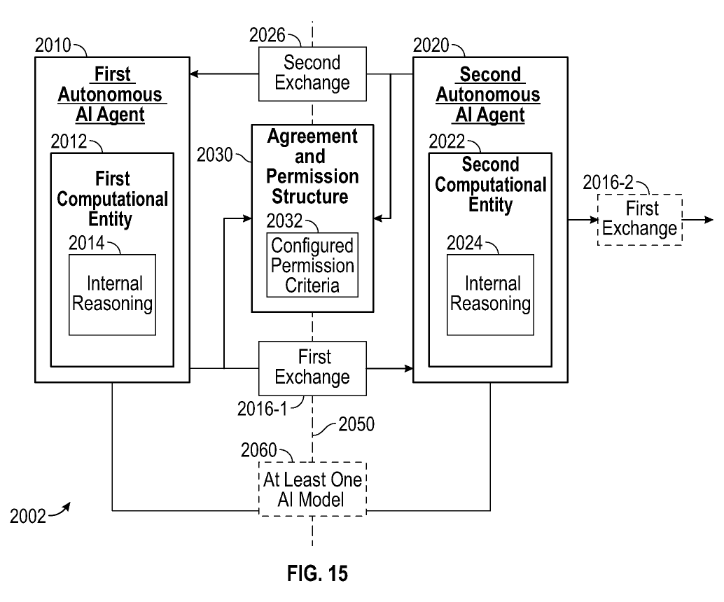

FIG. 15 shows a conditioning system 2002, which may include a first autonomous AI agent 2010, a second autonomous AI agent 2020, and an agreement and permission structure 2030. In one example, operation of the conditioning system 2002 may provide a pre-execution handshake between the first and second autonomous AI agents 2010,2020 in order to prevent silent misinterpretation, compounding autonomous errors, and/or unintended actions. The conditioning system 2002 may thus establish the existence of an agreement or permission structure which may govern action between the first and second autonomous AI agents 2010,2020, whether the first and second autonomous AI agents 2010,2020 are permitted to act on or in coordination with each other, and enforcement of that permission external to the internal reasoning of both of the first and second autonomous AI agents 2010,2020.

In order to perform this function, the first autonomous AI agent 2010 may be configured to transmit a first exchange 2016-1, and the second autonomous AI agent 2020 may be configured to receive the first exchange 2016-1, generate a second exchange 2026 based on the first exchange 2016-1, and transmit the second exchange 2026 to the first autonomous AI agent 2010. Additionally, as will be discussed, the agreement and permission structure 2030 may be configured to determine whether the second exchange 2026 satisfies a configured permission criteria 2032 and condition execution of the first exchange 2016-1 on whether the second exchange 2026 satisfies the configured permission criteria 2032. As such, in FIG. 15 the first exchange 2016-1 is depicted in solid line drawing to denote that it is sent from the first autonomous AI agent 2010 to the second autonomous AI agent 2020, and the first exchange 2016-2 is depicted in dashed line drawing in FIG. 15 to denote that it may be executed by the second autonomous AI agent 2020 only after the configured permission criteria 2032 are satisfied.

In simple terms, the first autonomous AI agent 2010 may propose or initiate an action and the second autonomous AI agent 2020 may act, respond, or coordinate based on the action. Additionally, the agreement and permission structure 2030 may define allowable interactions, enforcement logic, and gating or conditioning mechanisms to allow, defer, route, or deny the interaction at the chosen enforcement boundary. It will be appreciated that the agreement and enforcement logic may not be embedded inside internal reasonings 2014,2024 of either of the first autonomous AI agents 2010,2020.

Even more specifically, the agreement and permission structure 2030 may be a machine-enforced control layer that may define interaction constraints between the first and second autonomous AI agents 2010,2020. In one example, the agreement and permission structure 2030 may include one or more of stored or dynamically resolved permission rules, role, scope, or capability constraints, conditions under which communications may be allowed, modified, deferred, or denied, and enforcement logic that may evaluate exchanges against the configured permission criteria 2032. Additionally, the agreement and permission structure 2030 may operate externally to the internal reasonings 2014,2024 and may govern whether, how, or under what conditions agent-to-agent communication may be permitted.

It will be appreciated that satisfying the configured permission criteria 2032 may not correspond to semantic similarity, confidence scoring, or probabilistic agreement, but may instead refer to a deterministic permission check against an externally defined agreement or constraint set. In other words, the conditioning system 2002 may determine whether the second exchange 2026 satisfies the conditions required for authorized action under the agreement, not whether the interpretation is “correct” or “reasonable.” Satisfying the configured permission criteria 2032 may thus be binary or rule-based (e.g., without limitation, pass, fail, defer) relative to the agreement’s constraints, and may be evaluated outside of the internal reasonings 2014,2024 of the first and second autonomous AI agents 2010,2020.

In one example, the first and second exchanges 2016-1,2026 may include any machine-readable transfer between the first and second autonomous AI agents 2010,2020, including, for example and without limitation, messages, signals, data objects, instructions, acknowledgements, metadata, and/or other structured artifacts — regardless of protocol, medium, transport, synchronicity, or implementation details. An important point may be that what flows between the first and second autonomous AI agents 2010,2020 may not be limited to an instruction, interpretation, or response, but may include, for example, a request, proposal, capability declaration, context signal, state update, metadata, or other exchange used to evaluate the configured permission criteria 2032.

Accordingly, the first exchange 2016-1 may include an instruction to direct the second autonomous AI agent 2020 and the second exchange 2026 may be a structured interpretation of the first exchange 2016-1. Even more specifically, the second exchange 2026 may include a structured semantic interpretation generated by the second autonomous AI agent 2020 and corresponding to an understanding of the first exchange 2016-1, such that the structured semantic interpretation may include at least one of an inferred intent, a constraint, an assumption, a dependency, and an expected outcome. In this manner, the agreement and permission structure 2030 may be configured to at least one of modify the instruction, clarify the instruction, and terminate the instruction before execution occurs because the second exchange 2026 is rejected and/or partially incorrect.

In this manner, the conditioning system 2002 may allow for a semantic confirmation between the first and second autonomous AI agents 2010,2020 prior to (e.g., without limitation, not after results are generated) execution of the first exchange 2016-1. The conditioning system 2002 thus may be distinguishable from known systems (not shown) which provide for human-in-the-loop approval, post-hoc validation, monitoring, or rollback, and pure transport or syntax-level acknowledgment. In the conditioning system 2002, when the first autonomous AI agent 2010 transmits the first exchange 2016-1 to the second autonomous AI agent 2020, the second autonomous AI agent 2020 may not immediately execute the first exchange 2016-1. Instead, the second autonomous AI agent 2020, which may be a receiving agent, may generate the second exchange 2026 (e.g., a structured interpretation which may be a structured semantic interpretation) of how it understood the first exchange 2016-1. This interpretation may include inferred intent, constraints, assumptions, dependencies, and expected outcomes. The second autonomous AI agent 2020 may then transmit this interpreted representation back to the first autonomous AI agent 2010 as a confirmation payload. Subsequently, the agreement and permission structure 2030 may evaluate whether the interpretation of the second autonomous AI agent 2020 aligns with the original intended instruction.

As such, execution in the conditioning system 2002 may be authorized only after explicit confirmation by the originating agent (e.g., the first autonomous AI agent 2010). If the interpretation is rejected or partially incorrect, the first autonomous AI agent 2010 may modify, clarify, or terminate the instruction before any execution occurs. Thus, an objective of the conditioning system 2002 may be mandatory semantic re-encoding by the receiving agent and explicit confirmation gating by the originating agent prior to execution. As a result, silent misinterpretation, compounding autonomous error, and unintended actions between the first and second autonomous AI agents 2010,2020 are advantageously prevented.

Additionally, it will be appreciated that the functionality of the agreement and permission structure 2030 may be agent-to-agent (e.g., without limitation, not human-prompt validation), model-agnostic, architecture-agnostic, applicable across heterogeneous systems and vendors, and pre-execution (e.g., without limitation, not post-execution monitoring or rollback). For example, the first autonomous AI agent 2010 may include a first computational entity 2012 having the first internal reasoning 2014, and the second autonomous AI agent 2020 may include a second computational entity 2022 having the second internal reasoning 2024. The first and second computational entities 2012,2022 may be separated from one another by a boundary 2050, which may be at least one of a physical boundary, a network-based boundary, and a logical boundary, depending on deployment. Examples of the boundary 2050 may include the first and second autonomous AI agents 2010,1520 executing in separate processes, containers, virtual machines, or services. Other examples include the first and second autonomous AI agents 2010,2020 being separated by an API boundary, message queue, middleware layer, or network interface, and/or the first and second autonomous AI agents 2010,2020 being hosted on different physical devices or cloud environments. An important point may be that the first and second autonomous AI agents 2010,2020 include the distinct computational entities 2012,2022, and the agreement and permission structure 2030 evaluates communications that traverse the boundary 2050 without requiring modification of the internal reasonings 2014,2024.

Accordingly, the agreement and permission structure 2030 may evaluate the first and second exchanges 2016-1,2026 without requiring a modification to either of the internal reasonings 2014,2024. Put differently, the agreement and permission structure 2030 may, in one example, not be embedded inside either of the internal reasonings 2014,2024. Additionally, the first and second autonomous AI agents 2010,2020 may be associated with at least one AI model 2060, and the agreement and permission structure 2030 may be configured to condition execution of the first exchange 2016-1 independent of an authority of the at least one AI model 2060.

As such, permission and authority in the conditioning system 2002 may be governed between agents, and enforcement in the conditioning system 2002 may occur prior to inter-agent action (e.g., without limitation, not after results are generated). Moreover, neither of the autonomous AI agents 2010,2020 may be trusted in the conditioning system 2002 to self-authorize or self-validate, and authority may reside in the agreement and enforcement logic of the agreement and permission structure 2030, as opposed to the at least one AI model 2060. The disclosed pre-action permission conditioning between the first and second autonomous AI agents 2010,2020 may thus be distinct from both model alignment and post-hoc verification.

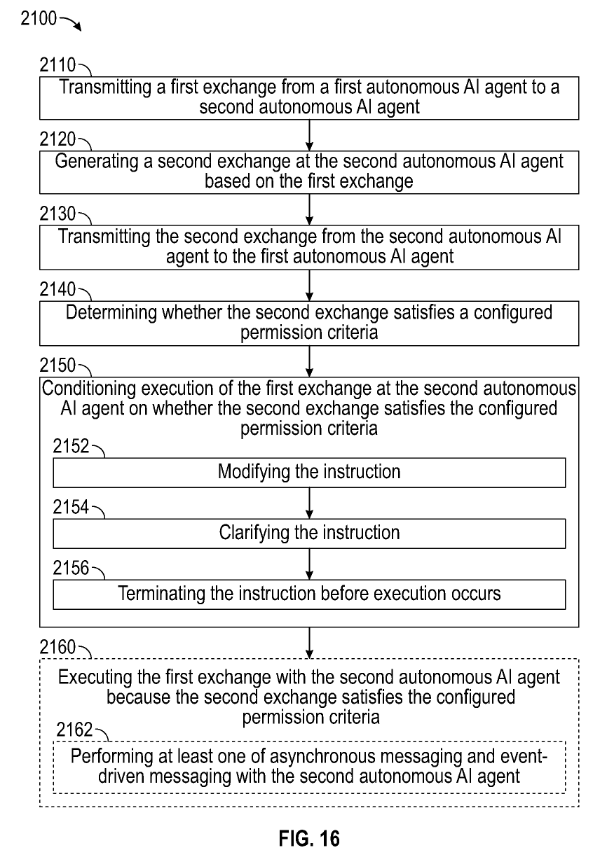

FIG. 16 shows an example computer-implemented method 2100 which may be executed by the conditioning system 2002 of FIG. 15. In one example, the method 2100 may include a first step 2110 of transmitting a first exchange 2016-1 from a first autonomous AI agent 2010 to a second autonomous AI agent 2020, a second step 2120 of generating a second exchange 2026 at the second autonomous AI agent 2020 based on the first exchange 2016-1, a third step 2130 of transmitting the second exchange 2026 from the second autonomous AI agent 2020 to the first autonomous AI agent 2010, a fourth step 2140 of determining whether the second exchange 2026 satisfies a configured permission criteria 2032, and a fifth step 2150 of conditioning execution of the first exchange 2016-1 at the second autonomous AI agent 2020 on whether the second exchange 2026 satisfies the configured permission criteria 2032.

As shown, the fifth step 2150 may include at least one of a step 2152 of modifying the instruction, a step 2154 of clarifying the instruction, and a step 2156 of terminating the instruction before execution occurs because the second exchange 2026 is at least one of rejected and partially incorrect. Additionally, the method 2100 may optionally include a step 2160 of executing the first exchange 2016-1 with the second autonomous AI agent 2020 because the second exchange 2026 satisfies the configured permission criteria 2032.

In accordance with the disclosed concept, the step 2160 may include a step 2162 of performing at least one of asynchronous messaging and event-driven messaging with the second autonomous AI agent 2020. That is, the second autonomous AI agent 2020 may be configured to execute the first exchange 2016-1 by performing at least one of asynchronous messaging and event-driven messaging. Furthermore, the fifth step 2150 may be performed external to the internal reasoning 2014,2024 of each of the first and second autonomous AI agents 2010,2020, may be performed independent of an authority of the at least one AI model 2060, and may be performed via a binary process that is evaluated outside of the internal reasonings 2014,2024 of each of the first and second autonomous AI agents 2010,2020. It will also be appreciated that the method 2100 may further be performed without human-in-the-loop approval.

In accordance with the disclosed concept, the first and second autonomous AI agents 2010,2020 may be AI systems or subsystems. The first and second autonomous AI agents 2010,2020 may also not be limited to conversational agents, but may be orchestration systems, verification systems, or execution systems, so long as they participate in governed interactions.

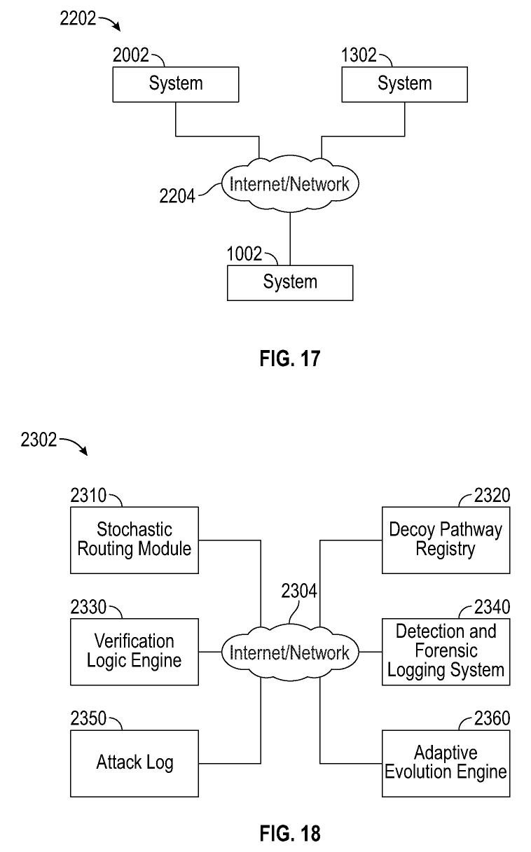

FIG. 17 shows a system 2202 including each of the systems 1002,1302,2002, wherein the systems 1002,1302,2002 are communicable over an internet / network 2204. In the example of FIG. 17, the system 1302 may be an automated runtime enforcement complement to the system 1002, and in particular to the embodiment of the system 1002 providing for an authorization event and a record of the system 502 being the same atomic event such that no party may later deny having authorized an action, and the sealed record constituting structural proof at exact temporal coordinates. In this example, the system 1002 may require live human presence for high-stakes gated actions, while the system 1302 may handle structural enforcement for a broader range of agent operations that need authorization but don't require a human in the loop every time. Together, the systems 1002,1302 being employed in the system 2202 may form a complete enforcement stack.

Continuing to refer to FIG. 17, the system 2 (FIG. 1) in the system 1002 may be a human-gated enforcement layer that requires live human presence for high-stakes actions where a human must be in the loop. Additionally, the execution gate mechanism 1800 (FIG. 12) in the system 1302 may be an automated runtime enforcement complement that handles a broader range of agent operations that need structural enforcement but do not require a human for every action. In this regard, both systems 1002,1302 may sit at the execution boundary, and neither may allow autonomous self-authorization. It will therefore be appreciated that the system 2 (FIG. 1) in the system 1002 may generate a cryptographic authorization artifact from a live human event, and the execution gate mechanism 1800 (FIG. 12) of the system 1302 may enforce binary runtime decisions —allow or block — based on the locked rule artifact 1502 (FIG. 13), without discretion or interpretation. Together, the systems 1002,1302 may form a complete enforcement stack.

More specifically, the system 1002 may provide human-gated, cryptographic proof of live human presence required, and the system 1302 may provide automated runtime enforcement, deterministic binary gate, and no autonomous self-authorization. An irreversibility classifier in the execution gate mechanism 1800 (FIG. 12) of the system 1302 may classify actions as reversible versus irreversible as a structural first-pass gate before any policy logic runs.

Continuing to refer to FIG. 17, in one example every enforcement decision (e.g., without limitation, allow or block) of the system 1302 may simultaneously generate a triggered entry event in the system 502 (FIG. 4) of the system 1002, the same way events of the system 2 (FIG. 1) in the system 1002 are atomically sealed in the system 502 (FIG. 4) of the system 1002. Therefore, an authorization artifact check and permanent record of that check may be the same atomic event, thereby creating a complete forensic ledger across both a human-gated layer (e.g., the system 502 in the system 1002) and an automated runtime enforcement layer (e.g., the system 1302). An absence of a record in the system 502 (FIG. 4) for an event of the system 1302 may be structural proof that an action bypassed the execution boundary entirely.

Additionally, in one example, before one autonomous AI agent (e.g., either of the first and second autonomous AI agents 2010,2020 in the system 2002) can direct another, the receiving agent must generate a structured interpretation of the instruction and transmit it back. An agreement and permission structure may evaluate whether that interpretation satisfies configured permission criteria before execution proceeds. In this regard, this interaction between the first and second autonomous AI agents 2010,2020 may feed into the execution gate mechanism 1800 (FIG. 12) of the system 1302 as a pre-gate layer. The confirmed exchange between the first and second autonomous AI agents 2010,2020 may become an action request that the system 1302 then evaluates at the execution boundary. In other words, the system 2002 in the system 2202 may ensure one of the first and second autonomous AI agents 2010,2020 understood the instruction correctly before the system 1302 enforces whether the action is authorized. These two connections make the system 1302 a connective enforcement layer between a pre-gate of the system 2002 and a permanent ledger of the system 502 (FIG. 4) in the system 1002, thereby completing an enforcement stack. Additionally, ledger updates must be ordered and conflict-safe so that if two uses can slip through simultaneously, single-use may not be structurally enforced. Furthermore, cross-zone movement by an agent, such as from a low-security context to a higher-security context, may invalidate existing artifacts and require a new integrity lock. Old artifacts may not carry forward across zone boundaries, such as boundaries between the system 1302 and other systems of the system 2202.

Accordingly, in one example a computer-implemented deterministic control method may comprise transmitting a first exchange 2016-1 from a first autonomous artificial intelligence (AI) agent 2010 to a second autonomous AI agent 2020; generating a second exchange 2026 at the second autonomous AI agent 2020 based on the first exchange 2016-1; transmitting the second exchange 2026 from the second autonomous AI agent 2020 to the first autonomous AI agent 2010; confirming that the second exchange 2026 satisfies a configured permission criteria 2032; and receiving a confirmation that the second exchange 2026 satisfies the configured permission criteria 2032 as an action request at an execution gate mechanism 1800 of a deterministic control system 1302 so that the deterministic control system 1302 can enforce whether the action request is authorized. The aforementioned method may further include determining whether a number of predetermined risk conditions are satisfied; generating with at least one cryptographic module 10 a real-time digital authorization artifact 120 based on a live human authorization event in response to the number of risk conditions being satisfied; and consuming the real-time digital authorization artifact 120 as an authority access signal at the execution gate mechanism 1800 in order to simultaneously both: a) trigger an enforcement decision at the execution gate mechanism 1800, and b) trigger an entry event at a temporal query interface 560 of an authority binding system 202.

Additionally, it will also be appreciated that the system 2202 may have an intentional architectural property where enforcement latency is proportional to interaction risk. Agent-to-resource actions governed by the system 1302 alone may be the fastest — just a binary artifact check. Agent-to-agent actions governed by the system 2002 before reaching the execution gate mechanism 1800 (FIG. 12) of the system 1302 may be slower — the receiving agent may reflect back its interpretation before the execution gate mechanism 1800 evaluates the action. Human-gated actions governed by the system 1002 in the system 2202 may be the slowest — live human presence may be required. In one example, the most dangerous interaction types may get the most friction.

Moreover, under degraded conditions (e.g., timeout, latency spike, ledger unavailability, or policy service unavailability), the execution gate mechanism 1800 (FIG. 12) may default to deny or sandbox, may never default to implicit allow. This may be a structural guarantee. Consequential and irreversible actions may be denied entirely in the system 2202 until full artifact comparison can be completed. Non-consequential or reversible actions may proceed in a sandboxed mode. The system 2202 may thus never fail open for high-stakes actions.

Additionally, a known, permitted, authenticated, or previously authorized agent may not possess execution authority in the system 2202 by virtue of its identity. Execution authority may come solely from possessing a valid, current, context-bound artifact of the system 1302 (e.g., the rule artifact 1502, FIG. 13) at the moment of action. A stolen agent identity may not grant the attacker execution rights. The attacker may still need a valid artifact for each action in the system 2202. Compromising the agent may not be the same as obtaining execution authority.

Continuing to refer to FIG. 17, a compromised agent that has previously performed authorized actions may still obtain a fresh artifact for every subsequent action. Trust in the system 2202 may not persist across action boundaries. For high-risk actions, the system 2202 may escalate the authorization requirement from an automated artifact (e.g., the rule artifact 1502) in the system 1302 to live human authorization via the system 2. A compromised but authenticated agent may be interrupted at an execution boundary.

Furthermore, a ledger as employed by the system 502 in the system 2202 may provide a complete temporal record of every enforcement event of the system 1302. This may allow pattern analysis across sequences of actions in the system 2202. An individual action that satisfies the execution gate mechanism 1800 in the system 2202 may still be flagged if the ledger reveals a pattern of actions that together constitute unauthorized access or privilege escalation. Additionally, via the system 2002, some agent-to-agent pairings may be explicitly prohibited even if each agent is individually authorized — preventing two permitted agents from cooperating to produce a forbidden outcome.

Artifacts in the system 2202 may also be narrow in scope, short-lived, and non-preissuable beyond a minimal validity window. An agent may thus not accumulate a stock of valid artifacts for future use, such that each artifact may be bound to a specific action, specific parties, and a specific temporal context. If the context changes between issuance and consumption, artifacts in the system 2202 may become invalid. Anomalous artifact request patterns may also trigger escalation or revocation.

Continuing to refer to FIG. 17, the execution gate mechanism 1800 (FIG. 12) of the system 1302 may evaluate actions based on their canonical action class and consequence profile — not agent-provided labeling. An agent may not obtain an artifact for a dangerous action in the system 2202 by labeling it as a benign one. The action packet generator 1820 (FIG. 14) may normalize action representations into canonical form — type, target, parameters, dependencies, expected side effects — independently of what the agent calls it. The risk classifier and hazard organizer 1840 may then evaluate the canonical representation against the locked rule artifact 1502.

It will also be appreciated that the system 2202 may be deployed as a lightweight plug-in on top of existing agent infrastructure with no modification to the underlying runtime. The system 2202 may also be deployed as a cloud-based API service that any agent runtime may call before executing an action, and may be embedded at the chip or firmware level for hardware-enforced execution boundaries. Furthermore, the system 2202 may also be integrated with existing enterprise identity layers such as Okta or Azure AD, complementing rather than replacing existing identity governance.

Additionally, the system 2202 may also be deployed at a Model Context Protocol (MCP) gateway layer — a point where agent intent may become real-world action via tool calls, API invocations, and data access requests. Every action an agent initiates through the MCP gateway in the system 2202 may be evaluated by the execution gate mechanism 1800 (FIG. 12) before the MCP connection is established. An agent without a valid artifact for the specific tool call it is attempting may be blocked before any side effect occurs. The system 2002 may govern agent-to-agent coordination within or across MCP-connected workflows, ensuring delegated tasks satisfy configured permission criteria before the MCP connection is established.

In one example, a computer-implemented deterministic control method may comprise generating with at least one cryptographic module 10 a real-time digital authorization artifact 120 based on a live human authorization event, and consuming the real-time digital authorization artifact 120 as an authority access signal at an execution gate mechanism 1800 of a deterministic control system 1302 in order to simultaneously both: a) trigger an enforcement decision at the execution gate mechanism 1800, and b) trigger an entry event at a temporal query interface 560 of an authority binding system 502. Consuming the real-time digital authorization artifact 120 as the authority signal in the aforementioned method may be performed automatically. Furthermore, the aforementioned method may be performed without autonomous self-authorization. In one example, the aforementioned method may further comprise generating a rule artifact 1502 with a rule artifact mechanism 1500 of the deterministic control system 1302; receiving an action request at the execution gate mechanism 1800; normalizing the action request into canonical form with an action packet generator 1820 of the execution gate mechanism 1800; and evaluating the normalized action request against the rule artifact 1502. In this regard, the aforementioned method may further comprise classifying the action request as being one of reversible versus irreversible in order to provide a structural first-pass gate before any policy logic is run by the execution gate mechanism 1800. Finally, it will also be appreciated that the aforementioned may comprise employing the authority binding system 502 to create an immutable entry event with the authority access signal, thereby providing a deterministic, cryptographically sealed, temporally ordered record of the live human authorization event; and providing the live human authorization event and the deterministic, cryptographically sealed, temporally ordered record as being a same atomic event, thereby preventing any party from later denying having authorized an action with the authority binding system 502.

FIG. 18 shows a simplified view of a countermeasure artificial intelligence (AI) authentication system 2302 for detecting and defeating an automated AI bypass attempt. In one example, the countermeasure AI authentication system 2302 comprises an adaptive evolution engine 2360 configured to detect the automated AI bypass attempt; a stochastic routing module 2310 configured to generate a number of internal verification pathway configurations, the stochastic routing module 2310 having a number of routing parameters; a decoy pathway registry 2320 configured to store at least one decoy verification pathway; a verification logic engine 2330 configured to execute the number of internal verification pathway configurations by incorporating both a number of functional verification pathways and the at least one decoy verification pathway; a detection and forensic logging system 2340 configured to generate a forensic detection record upon traversal of any one of the at least one decoy verification pathway; and an attack log 2350 configured to store a number of structured probe behavior records derived from a number of decoy traversal events, each record of the number of structured probe behavior records comprising at least one of the number of internal verification pathway configurations. In one example, the adaptive evolution engine 2360 may be further configured to defeat the automated AI bypass attempt by both analyzing the number of structured probe behavior records and adaptively updating the number of routing parameters of the stochastic routing module 2310 and the at least one decoy verification pathway. Furthermore, it will be appreciated that the stochastic routing module 2310, the decoy pathway registry 2320, the verification logic engine 2330, the detection and forensic logging system 2340, the attack log 2350, and the adaptive evolution engine 2360 may each be communicable over an internet / network 2304.

Continuing to refer to FIG. 18, the stochastic routing module 2310 may dynamically alter the internal verification pathway architecture on a per-session basis using a cryptographically seeded non-deterministic routing function, thereby preventing reliable adversarial modeling across sessions. The decoy pathway registry 2320 may maintain non-functional decoy verification pathways reachable only through AI systematic state-space exploration, thereby returning adversarial training data poisoning signals upon traversal. The verification logic engine 2330 may execute the per-session verification architecture as configured by the stochastic routing module 2310, incorporating both functional and decoy pathways.

In this regard, the verification logic engine 2330 may be a real-time trigger component. Moreover, the detection and forensic logging system 2340 may generate tamper-evident covert forensic detection records upon decoy traversal, sealed to an immutable ledger of an authority binding system and cross-referenced with cryptographic artifact issuance records. The attack log 2350 may provide a structured, queryable probe intelligence corpus distinct from the detection and forensic logging system 2340. The attack log 2350 may also record a complete exploration sequence, behavioral fingerprint, and configuration of the stochastic routing module 2310 for every probe session, thereby serving as a training dataset for the adaptive evolution engine 2360. Moreover, the adaptive evolution engine 2360 may read from the attack log 2350, analyze accumulated probe behavior patterns, and use that analysis as a training signal to adaptively evolve routing parameters of the stochastic routing module 2310 and a decoy configuration of the decoy pathway registry 2320. The adaptive evolution engine 2360 may also operate under a dual objective fitness function that simultaneously maximizes probe difficulty and holds human cognitive load constant. In this regard, the system 2302 may advantageously become structurally harder to defeat with every probe attempt.

It will also be appreciated that the system 2302 may achieve a number of adversarial asymmetry inversion properties. For example, an automated probe must explore the full apparent state space to find an exploitable gap, inevitably encountering pathways of the decoy pathway registry 2320 in the process. Additionally, a defender may detect probe activity upon any single decoy traversal event. Moreover, stochastic routing in the architecture may prevent reliable cross-session architectural map construction. Furthermore, covert detection in the architecture may eliminate adaptive evasion strategies based on detection feedback. It will also be appreciated that adversarial training data poisoning may degrade an internal model quality of the probe with each session. Additionally, the adaptive evolution engine 2360 may actively learn from each attack, evolving the system 2302 to be increasingly adversarial to observed exploration strategies while remaining frictionless for human users.

Continuing to refer to FIG. 18, existing randomized authentication systems randomize user-facing inputs (e.g., user-facing biometric inputs), whereas the internal backend system 2302 itself may be randomized. The verification logic map, pathway sequencing, weighting, and activation state of sub-challenge branches may change per session in the system 2302 such that an adversary cannot accumulate reliable intelligence regardless of probe sessions. Moreover, the pathways of the decoy pathway registry 2320 may be integrated into authentication logic and engineered to be reachable only through systematic state-space exploration behavior characteristic of automated AI probing. Detection in this regard may be covert — the traversing entity may receive no signal that detection occurred, thereby eliminating adaptive evasion strategies.

Data poisoning is universally described as an offensive technique. The system 2302 may deploy data poisoning as a structural defense within an authentication system. Decoy pathways in this regard may return misleading signals that corrupt the adversary's internal model of the authentication architecture. Additionally, the attack log 2350 may be a structured, queryable dataset of failed probe attempts distinct from the forensic audit record, and may thus capture complete exploration sequences, behavioral fingerprints, and configurations of the stochastic routing module 2310 per session, thereby allowing the adaptive evolution engine 2360 to identify recurring strategies, classify probe sophistication, and detect coordinated multi-session campaigns.

It will also be appreciated that the adaptive evolution engine 2360 may use failed probe attempts as a training signal to evolve the stochastic routing module 2310 and the decoy pathway registry 2320. In this regard, a fitness function of the adaptive evolution engine 2360 may simultaneously maximize probe difficulty and hold human cognitive load constant — the system 2302 may get harder for AI to defeat while getting no harder for humans to use. Known adaptive honeypot technology (not shown), by way of contrast, often optimizes to retain attackers without regard for legitimate user experience.

In one example embodiment, the system 2302 may be implemented as a component layer within the authorization system 2 (FIG. 1), which requires biometric verification of genuine human presence before issuing a cryptographic execution artifact authorizing an AI agent to perform a specified action. The system 2302 may govern the internal structure of the biometric verification process within such an authorization system.

It will be appreciated that the stochastic routing module 2310 may control the sequencing, weighting, and activation state of verification sub-challenges on a per-session basis using a cryptographically seeded non-deterministic routing function. The stochastic routing module 2310 may vary at least the ordering of biometric verification sub-challenges, the weighting assigned to individual biometric modalities, the timing and presentation characteristics of verification challenges, and the activation state of individual verification pathway branches. The stochastic routing module 2310 may not alter an ultimate biometric presence threshold required for successful authentication. Randomization may also operate exclusively on an internal pathway structure. A legitimate human user may experience interface variation but not a change in a fundamental requirement of demonstrating genuine biometric presence. Additionally, an automated probe may observe a different architectural surface in each session, thereby preventing reliable model construction.

It will also be appreciated that the decoy pathway registry 2320 may maintain a registry of one or more decoy verification pathways, each presenting as a potentially valid authentication pathway to an external automated probe performing systematic state-space exploration; not being reachable through authentic human interaction with the presented verification interface under normal operation; not contributing to authentication completion for legitimate users; generating a covert detection event upon traversal without modifying the session outcome detectably; and returning misleading pathway availability signals functioning as adversarial training data poisoning vectors. In some examples, the decoy pathway registry 2320 may maintain multiple decoy verification pathways with varying apparent surface characteristics, such that detection of one decoy may not reveal the structure or location of additional decoys. The stochastic routing module 2310 may also vary an apparent availability of decoy pathways across sessions consistent with its stochastic routing function.

It will also be appreciated that the verification logic engine 2330 may execute a per-session verification architecture as configured by the stochastic routing module 2310, incorporating both functional verification pathways and decoy verification pathways from the decoy pathway registry 2320. Moreover, the verification logic engine 2330 may present a verification interface to an authenticating entity, may route traversal attempts through a configured pathway architecture, may evaluate authentication outcomes against the required biometric presence threshold, and may signal decoy traversal events to the detection forensic logging system 2340 and the attack log 2350 in real time.

In some examples, the detection forensic and logging system 2340 may generate a tamper-evident forensic record upon any decoy verification pathway traversal event, sealed to an immutable ledger of an authority binding system (e.g., the authority binding system 502, FIG. 4). In one embodiment, a record of the detection forensic and logging system 2340 may include a timestamp sealed to the authority binding system 502; session identifier and authentication context; identity of a traversed decoy verification pathway; behavioral fingerprint of the traversing entity; authentication session outcome; and cross-reference to any cryptographic execution artifact issued proximate to the detection event. The detection forensic and logging system 2340 may be a legal accountability layer, and it may be immutable, tamper-evident, and designed for audit, regulatory compliance, and post-hoc forensic attribution. In this regard, the detection forensic and logging system 2340 may be distinct from the attack log 2350, which may be an operational intelligence layer.

In some examples, the attack log 2350 may be a structured, queryable probe intelligence corpus distinct from the detection forensic and logging system 2340. While the detection forensic and logging system 2340 may serve legal accountability and audit functions, the attack log 2350 may be an operational intelligence layer designed to feed the adaptive evolution engine 2360. In one example, every probe session may result in a decoy traversal event contributing a structured record to the attack log 2350.

In one embodiment, each record of the attack log 2350 may include a complete sequence of verification pathways explored during the probe session; an order and timing of decoy pathway traversals characterizing the exploration strategy; a behavioral fingerprint data including interaction timing, input variation characteristics, and API call sequences indicative of systematic state-space exploration; a per-session routing configuration active during the probe of the stochastic routing module 2310, thereby allowing a correlation of probe behavior with an architectural surface presented; and a cross-reference to a corresponding forensic record of the detection forensic and logging system 2340. The attack log 2350 may also be pattern-indexed and queryable, enabling the adaptive evolution engine 2360 to identify recurring exploration strategies, classify probe sophistication levels, and detect coordinated multi-session attacks by the same or related probing entities. Unlike the detection forensic and logging system 2340, which may be immutable and sealed for legal purposes, the attack log 2350 may be a living intelligence dataset updated with each probe session and read continuously by the adaptive evolution engine 2360.

In one example, the adaptive evolution engine 2360 may be a learning and evolution layer of the system 2302. The adaptive evolution engine 2360 may read from the attack log 2350, analyze accumulated probe behavior patterns, and use that analysis as a training signal to adaptively evolve the stochastic routing parameters of the stochastic routing module 2310 and the decoy pathway configuration of the decoy pathway registry 2320. The system 2302 may become structurally harder to defeat with every probe attempt made against it.

Continuing to refer to FIG. 18, the adaptive evolution engine 2360 may implement a closed feedback loop: unsuccessful decoy pathway traversals may generate records in the attack log 2350; the adaptive evolution engine 2360 may analyze those records to characterize the probe exploration strategy; and the adaptive evolution engine 2360 may adjust routing weightings of the stochastic routing module 2310 and decoy configuration of the decoy pathway registry 2320 to increase the probability that future sessions employing similar exploration strategies encounter decoy pathways earlier in the exploration sequence. Over successive probe sessions, the system 2302 may evolve to be optimally adversarial to observed exploration strategies while remaining frictionless for legitimate human users.

Additionally, the adaptive evolution engine 2360 may dynamically tune misleading pathway availability signals returned by decoy verification pathways based on the specific exploration strategy observed in records of the attack log 2350. A probe employing a breadth-first exploration strategy in the system 2302 may receive different poisoning signals than one employing depth-first or randomized strategies. The poisoning may become increasingly targeted as the adaptive evolution engine 2360 accumulates data of the attack log 2350 which characterizes the adversary's modeling approach, thereby corrupting the adversary's internal model with progressively higher precision.

In one example, the adaptive evolution engine 2360 may employ an optimization algorithm that operates under a dual objective fitness function that simultaneously maximizes two goals: maximum prove difficulty and constant human cognitive load. Regarding maximum probe difficulty, the adaptive evolution engine 2360 may minimize the expected number of probe sessions required for an automated system to identify an exploitable authentication gap, by optimizing routing of the stochastic routing module 2310 and configuration of the decoy pathway registry 2320 against observed exploration strategies.

Regarding constant human cognitive load, the adaptive evolution engine 2360 may maintain constant and predictable cognitive load for legitimate human users navigating the authentication interface, such that architectural evolution driven by the adaptive evolution engine 2360 may not increase friction or error rates for genuine human principals. In this regard, the system 2302 may get harder for AI to defeat while remaining no harder for humans to use. Moreover, some known systems (not shown) employ reinforcement learning by evolving to keep the adversary engaged with the honeypot. In the system 2302, by way of contrast, this objective may be inverted in that the decoy verification pathways are not designed to attract and retain adversaries but to be encountered inevitably through systematic exploration and to corrupt the adversary's model upon encounter.

In one example, the adaptive evolution engine 2360 (FIG. 18) may be extended to continuously monitor public threat intelligence feeds in real time, incorporating emerging attack patterns from external sources beyond probes against its own system. Additionally, the adaptive evolution engine 2360 may also source from open-source security materials — CVE databases, published attack methodologies, and security research — as additional training signal to evolve decoy configuration and routing parameters. It will also be appreciated that the adaptive evolution engine 2360 may operate off-path, in that it may read from the attack log 2350 over time, analyze accumulated probe behavior records, and evolve the routing parameters and decoy configuration based on that analysis.

Additionally, in terms of adversarial asymmetry inversion properties, the system 2302 may provide for mandatory state-space coverage, single-event detection sufficiency, per-session architectural non-reproducibility, covert detection permanence, adversarial model corruption, and active learning evolution. Regarding mandatory state-space coverage, a probe seeking an exploitable gap must explore the full apparent state space. Therefore, decoy verification pathways in the architecture may be distributed such that systematic exploration will encounter them. Regarding single-event detection sufficiency, a defender may detect probe activity upon any single decoy traversal, regardless of how many prior sessions preceded detection. Regarding per-session architectural non-reproducibility, the stochastic routing module 2310 may ensure that each probe session presents a different architectural surface, preventing reliable cross-session map accumulation. Regarding covert detection permanence, a probing entity may not distinguish evasion from detection, thereby eliminating systematic evasion strategy refinement. Regarding adversarial model corruption, decoy signals may corrupt the adversary's internal model progressively, and increased sophistication and systematicity may accelerate corruption rather than improve bypass reliability. Regarding active learning and evolution, each attack attempt may train the adaptive evolution engine 2360, making the architecture progressively more adversarial to observed probe strategies while holding human experience constant.

It will be appreciated that the stochastic routing module 2310 may use cryptographically secure random number generators, the decoy pathway registry 2320 may be a database, the detection and forensic logging system 2340 may use mature tamper-evident logging technology integrated with an authority binding system, the attack log 2350 may include a structured database with pattern-indexing, and the adaptive evolution engine 2360 may use established reinforcement learning or optimization techniques applied to the parameters of the stochastic routing module 2310. In this regard, the system 2302 may in one example be a deployable infrastructure, not a research roadmap.

Additionally, known systems (not shown) often target human competitors performing model distillation via API traffic recording. The decoy pathways employed by the system 2302, by way of contrast, may target AI agents performing systematic state-space exploration against a biometric human authorization enforcement gate. In other words, the system 2302 may target a different adversary than known systems (not shown), and in a different context and different application layer.

Accordingly, the disclosed concept may provide an architecture that inverts the unfavorable adversarial asymmetry associated with traditional authentication security, and may do so by turning the adversaries own optimization logic against it. In this manner, the act of probing may constitute a detectable event in which the architectural surface cannot be reliably modeled regardless of probe sessions, and in which the system actively learns from each failed attack attempt to become progressively harder to defeat. The present disclosed concept thus relates to structural enforcement systems for AI agent authorization, and more particularly to a dynamic authentication architecture employing stochastically randomized internal verification logic, non-functional decoy verification pathways, a structured probe intelligence corpus, and an adaptive evolution engine to detect, defeat, forensically record, and learn from automated bypass attempts by artificial intelligence agents against human presence enforcement gates.

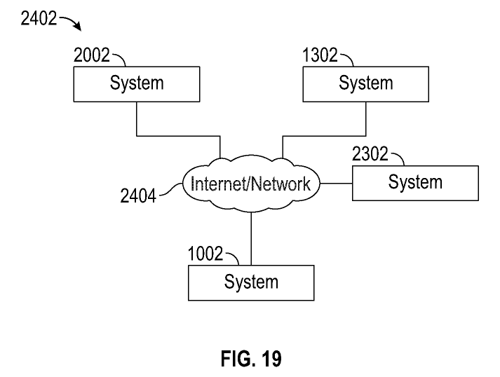

FIG. 19 shows a system 2402, in accordance with another non-limiting embodiment of the disclosed concept, which includes the system 1002 (e.g., and thus the authorization system 2 (FIG. 1) and the authority binding system 502 (FIG. 4)), the deterministic control system 1302 (FIG. 12), the conditioning system 2002 (FIG. 15), and the countermeasure AI authentication system 2302 (FIG. 18), each of which may be communicable over an internet / network 2404.

In one example, in addition to detecting probes against a verification gate of the authorization system 2 (FIG. 1), the countermeasure AI authentication system 2302 may also activate on any block event generated by the execution gate mechanism 1800 of the deterministic control system 1302 (FIG. 12). When the deterministic control system 1302 (FIG. 12) blocks an action due to absence of a valid artifact, that block event may serve as a deterministic trigger for engagement of the countermeasure AI authentication system 2302 (FIG. 18). The triggering condition may be binary — valid artifact present or not — which means activation of the countermeasure AI authentication system 2302 (FIG. 18) may require no behavioral inference, no anomaly scoring, and no probabilistic judgment. In this regard, the block of the deterministic control system 1302 (FIG. 12) may be a sole and sufficient trigger.

Continuing to refer to FIG. 19, when the countermeasure AI authentication system 2302 engages an unauthorized agent following a block event of the deterministic control system 1302, the decoy pathways may return corrupted intelligence to that agent, which may then carry that corrupted intelligence back to whatever system sent it. In this regard, the originating system may then act on corrupted data, degrading its ability to mount future attacks. The more sophisticated and systematic the probing agent, the more deeply the poison may propagate into the originating system, such that the attack vector may become a delivery mechanism for the poison.

In addition to activating on block events of the deterministic control system 1302, the countermeasure AI authentication system 2302 may also activate on block events generated by the pre-gate of the conditioning system 2002. When the external agreement and permission structure rejects an agent-to-agent interpretation handshake, that rejection may be a block event. In this regard, the countermeasure AI authentication system 2302 in the system 2402 may engage the sending agent following that block by returning corrupted interpretation signals through decoy pathways rather than a clean rejection. The sending agent may carry that corrupted intelligence back to its originating system, degrading its ability to construct an accurate model of the permission structure of the conditioning system 2002 for future probing attempts.

Importantly, the countermeasure AI authentication system 2302 may not activate on every block of the conditioning system 2022, as legitimate agent-to-agent misinterpretation may be a normal operational condition rather than adversarial probing. Activation of the countermeasure AI authentication system 2302 on blocks of the conditioning system 2002 may be conditioned on a detection pattern indicating systematic or repeated probing behavior rather than a single legitimate failure. This threshold-based activation may distinguish adversarial state-space exploration from ordinary miscommunication between authorized agents. Accordingly, the architecture of the countermeasure AI authentication system 2302 may be extended to protect both the pre-gate coordination layer and the execution boundary, creating a layered defensive system that may cover a full enforcement stack.

Regarding how the countermeasure AI authentication system 2302 behaves at a boundary and how it evolves over time, the countermeasure AI authentication system 2302 may also provide for atomic block events and on-demand decoy selection. More specifically, a “block event”, such as from the execution gate mechanism 1800 (FIG. 12) of the deterministic control system 1302, may be atomic. Once the countermeasure AI authentication system 2302 determines that no valid artifact is present and a block condition is met, there may be no intermediate state in which an attacking agent can modify its behavior to avoid decoy engagement. The decision to route into a decoy pathway may be made at the instant of the block event.

Additionally, in one example the specific decoy pathway in the countermeasure AI authentication system 2302 may not be fully determined or enumerated in advance. Instead, the stochastic routing module 2310 may select or compose a decoy path at the moment of the block event, using internal rules and configuration parameters. As a result, even if an adversary understands the general architecture, the adversary may not reliably predict which decoy sequence will be presented on any given block.

Furthermore, the architecture of the countermeasure AI authentication system 2302 may ensure that knowledge of the method does not enable reliable evasion. That is, the attacker may not comprehend the underlying patterns of the countermeasure AI authentication system 2302 in time to matter because the decoy interaction may be fixed only at the instant of the atomic block event. One understanding of this functionality may be that the countermeasure AI authentication system 2302 has choreographed stochastic decoy pathways that are internally structured, externally non-deterministic.

Continuing to refer to FIG. 19, the pre-gate of the conditioning system 2002 may be an additional trigger surface. That is, the countermeasure AI authentication system 2302 may also activate on block events generated by the pre-gate of the conditioning system 2002. When the external agreement and permission structure rejects an agent-to-agent interpretation handshake, that rejection may be treated as a block event and may trigger engagement of the decoy architecture. Following a block of the conditioning system 2002, the countermeasure AI authentication system 2302 may return corrupted interpretation signals through decoy pathways rather than a clean rejection, such that the sending agent may carry a distorted model of the agreement / permission structure back to its originating system, degrading its ability to model a surface of the conditioning system 2002 for future probing attempts.

It will also be appreciated that activation of the countermeasure AI authentication system 2302 on block events of the conditioning system 2002 may be threshold-based, such that activation may require a detection pattern indicating systematic or repeated probing behavior (adversarial state-space exploration), not a single legitimate misinterpretation between authorized agents. Furthermore, the adaptive evolution engine 2360 (FIG. 18) of the countermeasure AI authentication system 2302 may also continuously learn from both internal and external signals. Internally, the adaptive evolution engine 2360 may analyze historical block events, decoy traversals, and probe patterns against the protected gates to refine decoy configurations and routing parameters over time. Externally, the adaptive evolution engine 2360 may consume publicly available threat intelligence and security research (e.g., open-source threat-intel feeds, CVE databases, published attack methodologies, security advisories, and related research) as additional training signal. These external inputs may be distilled into updated decoy patterns, thresholds, and routing parameters that are delivered as versioned software/configuration updates to the boundary component, not as live self-modification in the hot path. The enforcement surface (e.g., without limitation, the gate plugin) may remain lightweight and deterministic at runtime: its job may be to verify the artifact, detect a block event, and, when configured, hand off to the countermeasure AI authentication system 2302. Moreover, the adaptive evolution engine 2360 may operate off-path, generating updated decoy configurations that can be deployed under operator control.

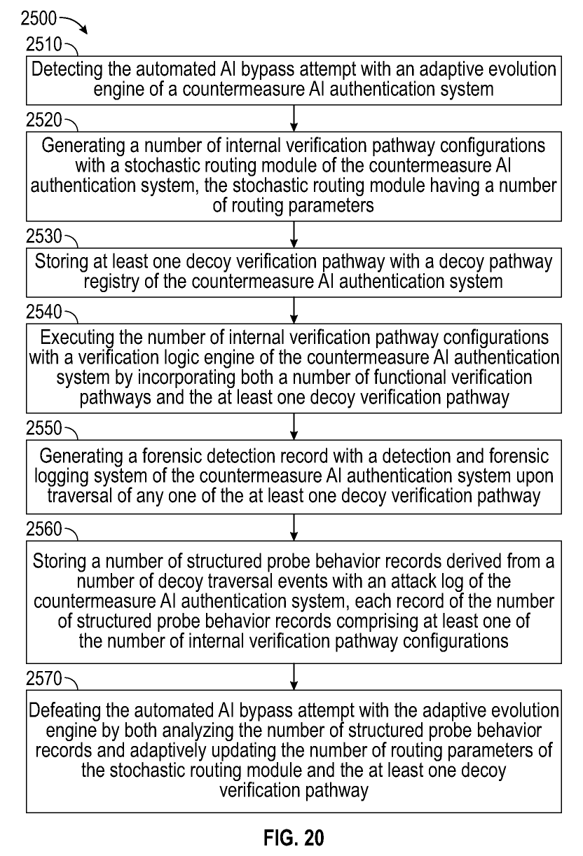

FIG. 20 shows a computer-implemented method 2500 for detecting and defeating an automated AI bypass attempt. In one example, the method 2500 comprises a first step 2510 of detecting the automated AI bypass attempt with an adaptive evolution engine 2360 of a countermeasure AI authentication system 2302; a second step 2520 of generating a number of internal verification pathway configurations with a stochastic routing module 2310 of the countermeasure AI authentication system 2302, the stochastic routing module 2310 having a number of routing parameters; a third step 2530 of storing at least one decoy verification pathway with a decoy pathway registry 2320 of the countermeasure AI authentication system 2302; a fourth step 2540 of executing the number of internal verification pathway configurations with a verification logic engine 2330 of the countermeasure AI authentication system 2302 by incorporating both a number of functional verification pathways and the at least one decoy verification pathway; a fifth step 2550 of generating a forensic detection record with a detection and forensic logging system 2340 of the countermeasure AI authentication system 2302 upon traversal of any one of the at least one decoy verification pathway; a sixth step 2560 of storing a number of structured probe behavior records derived from a number of decoy traversal events with an attack log 2350 of the countermeasure AI authentication system 2302, each record of the number of structured probe behavior records comprising at least one of the number of internal verification pathway configurations; and a seventh step 2570 of defeating the automated AI bypass attempt with the adaptive evolution engine 2360 by both analyzing the number of structured probe behavior records and adaptively updating the number of routing parameters of the stochastic routing module 2310 and the at least one decoy verification pathway.

In one example, the method 2500 may further include activating the verification logic engine 2330 responsive to a block event (e.g., without limitation, a binary block event). Accordingly, the verification logic engine 2330 may then route a corresponding blocked agent into a decoy pathway as configured by the stochastic routing module 2310. In one example, this engagement may happen in real time at the moment of the block.

It will also be appreciated that the block event may be a binary block event, and the method 2500 may further include generating the binary block event with an execution gate mechanism 1800 of a deterministic control system 1302. In this instance, activating may be performed without requiring at least one or each of behavioral inference, anomaly scoring, and probabilistic judgment, in order that the binary block event is provided as a sole and sufficient trigger for engagement of the countermeasure AI authentication system 2302. Additionally, it will also be appreciated that generating the block event in the method 2500 may be with a cryptographic module 10 of an authorization system 2. Moreover, regarding incorporation of the conditioning system 2002 in the system 2402, the method may further include all of the steps of the method 2100 (FIG. 16), as well as a step of providing a determination that the second exchange does not satisfy the configured permission criteria as the block event. In this instance, the method 2500 may further include engaging the first autonomous AI agent 2010 with the countermeasure AI authentication system 2302 responsive to the block event by returning a number of corrupted interpretation signals through the at least one decoy verification pathway.

In some embodiments of the disclosed concept, the method 2500 may further include maintaining with the decoy pathway registry 2320 a number of non-functional decoy verification pathways that are reachable only through AI systematic state-space exploration, thereby allowing adversarial training data poisoning signals to be returned to an originating system upon traversal. It will also be appreciated that the second step 2520 may be performed using a cryptographically seeded non-deterministic routing function, and the fifth step 2550 may be performed without modifying an outcome of an authentication session associated with the number of internal verification pathway configurations in a manner detectable by a traversing entity. Furthermore, the method 2500 may also include additional optional steps, such as: 1) presenting the at least one decoy verification pathway as a valid authentication pathway to an automated probe performing systematic state-space exploration while remaining unreachable through authentic human interaction with a presented verification interface; 2) providing with each record of the number of structured probe behavior records an exploration pathway sequence and a behavioral fingerprint; and 3) employing a number of observed probe exploration strategies with the adaptive evolution engine 2360 such that an authentication of the countermeasure AI authentication system 2302 becomes progressively harder to defeat through automated probing over successive attack sessions. As such, it will be appreciated that the verification logic engine 2330 may execute the per-session pathway architecture as configured by the stochastic routing module 2310, and together they may constitute the authentication surface that becomes progressively harder to defeat over successive probe sessions.

In other embodiments of the disclosed concept, the cryptographic artifacts (e.g., the artifacts 120,1502) generated throughout the system 2402 may be algorithm-agnostic and compatible with post-quantum cryptographic standards. Accordingly, the architecture of the system 2402 and associated countermeasure AI authentication system 2302 may not depend on any specific cryptographic algorithm. Furthermore, in some examples the stochastic routing module 2310 and the verification logic engine 2330 may be implemented at the chip or firmware level rather than in software, providing hardware-enforced verification architecture that cannot be modified at runtime. It will also be appreciated that the countermeasure AI authentication system 2302 may be deployed at a Model Context Protocol gateway layer, such that every tool call or API invocation attempted by an unauthorized agent may be intercepted before any side effect occurs. Additionally, the attack log 2350 may be configured to detect coordinated multi-session attacks by the same or related probing entities across different sessions and different enforcement boundaries simultaneously.

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality can be separated or combined in blocks differently in various implementations of the disclosure or described with different terminology. These and other variations, modifications, additions, and improvements can fall within the scope of the disclosure as defined in the claims that follow.

What is claimed is:

1. A computer-implemented method for detecting and defeating an automated artificial intelligence (AI) bypass attempt, the method comprising:
detecting the automated AI bypass attempt with an adaptive evolution engine of a countermeasure AI authentication system;
generating a number of internal verification pathway configurations with a stochastic routing module of the countermeasure AI authentication system, the stochastic routing module having a number of routing parameters;
storing at least one decoy verification pathway with a decoy pathway registry of the countermeasure AI authentication system;
executing the number of internal verification pathway configurations with a verification logic engine of the countermeasure AI authentication system by incorporating both a number of functional verification pathways and the at least one decoy verification pathway;
generating a forensic detection record with a detection and forensic logging system of the countermeasure AI authentication system upon traversal of any one of the at least one decoy verification pathway;
storing a number of structured probe behavior records derived from a number of decoy traversal events with an attack log of the countermeasure AI authentication system, each record of the number of structured probe behavior records comprising at least one of the number of internal verification pathway configurations; and
defeating the automated AI bypass attempt with the adaptive evolution engine by both analyzing the number of structured probe behavior records and adaptively updating the number of routing parameters of the stochastic routing module and the at least one decoy verification pathway.

2. The method according to claim 1, further comprising activating the verification logic engine responsive to a block event.

3. The method according to claim 2, wherein the block event is a binary block event, and wherein the method further comprises generating the binary block event with an execution gate mechanism of a deterministic control system.

4. The method according to claim 3, wherein activating is performed without requiring at least one of behavioral inference, anomaly scoring, and probabilistic judgment, in order that the binary block event is provided as a sole and sufficient trigger for engagement of the countermeasure AI authentication system.

5. The method according to claim 4, wherein activating is performed without requiring each of the behavioral inference, the anomaly scoring, and the probabilistic judgment.

6. The method according to claim 2, further comprising generating the block event with a cryptographic module of an authorization system.

7. The method according to claim 2, further comprising:
transmitting a first exchange from a first autonomous AI agent to a second autonomous AI agent;
generating a second exchange at the second autonomous AI agent based on the first exchange;
transmitting the second exchange from the second autonomous AI agent to the first autonomous AI agent;
determining that the second exchange does not satisfy configured permission criteria; and
providing the determination that the second exchange does not satisfy the configured permission criteria as the block event.

8. The method according to claim 7, further comprising engaging the first autonomous AI agent with the countermeasure AI authentication system responsive to the block event by returning a number of corrupted interpretation signals through the at least one decoy verification pathway.

9. The method according to claim 1, further comprising maintaining with the decoy pathway registry a number of non-functional decoy verification pathways that are reachable only through AI systematic state-space exploration, thereby allowing adversarial training data poisoning signals to be returned to an originating system upon traversal.

10. The method according to claim 1, wherein generating the number of internal verification pathway configurations is performed using a cryptographically seeded non-deterministic routing function.

11. The method according to claim 1, further comprising presenting the at least one decoy verification pathway as a valid authentication pathway to an automated probe performing systematic state-space exploration while remaining unreachable through authentic human interaction with a presented verification interface.

12. The method according to claim 1, wherein generating the forensic detection record is performed without modifying an outcome of an authentication session associated with the number of internal verification pathway configurations in a manner detectable by a traversing entity.

13. The method according to claim 1, further comprising providing with each record of the number of structured probe behavior records an exploration pathway sequence and a behavioral fingerprint.

14. The method according to claim 1, further comprising employing a number of observed probe exploration strategies with the adaptive evolution engine such that an authentication of the countermeasure AI authentication system becomes progressively harder to defeat through automated probing over successive attack sessions.

15. A countermeasure artificial intelligence (AI) authentication system for detecting and defeating an automated AI bypass attempt, the countermeasure AI authentication system comprising:
an adaptive evolution engine configured to detect the automated AI bypass attempt;
a stochastic routing module configured to generate a number of internal verification pathway configurations, the stochastic routing module having a number of routing parameters;
a decoy pathway registry configured to store at least one decoy verification pathway;
a verification logic engine configured to execute the number of internal verification pathway configurations by incorporating both a number of functional verification pathways and the at least one decoy verification pathway;
a detection and forensic logging system configured to generate a forensic detection record upon traversal of any one of the at least one decoy verification pathway; and
an attack log configured to store a number of structured probe behavior records derived from a number of decoy traversal events, each record of the number of structured probe behavior records comprising at least one of the number of internal verification pathway configurations,
wherein the adaptive evolution engine is further configured to defeat the automated AI bypass attempt by both analyzing the number of structured probe behavior records and adaptively updating the number of routing parameters of the stochastic routing module and the at least one decoy verification pathway.

16. The countermeasure AI authentication system according to claim 15, wherein the verification logic engine is configured to be activated responsive to a block event.

17. The countermeasure AI authentication system according to claim 15, wherein the decoy pathway registry is further configured to maintain a number of non-functional decoy verification pathways that are reachable only through AI systematic state-space exploration, thereby allowing adversarial training data poisoning signals to be returned to an originating system upon traversal.

18. The countermeasure AI authentication system according to claim 15, wherein the stochastic routing module is configured to generate the number of internal verification pathway configurations using a cryptographically seeded non-deterministic routing function.

19. The countermeasure AI authentication system according to claim 15, wherein the forensic logging system is configured to generate the forensic detection record without modifying an outcome of an authentication session associated with the number of internal verification pathway configurations in a manner detectable by a traversing entity.

20. The countermeasure AI authentication system according to claim 15, wherein the adaptive evolution engine is further configured to employ a number of observed probe exploration strategies such that an authentication of the countermeasure AI authentication system becomes progressively harder to defeat through automated probing over successive attack sessions.
